(19) United States
(12) Patent Application Publication
(10) Pub. No.: US 2004/0093340 A1
(43) Pub. Date: May 13, 2004

(54) Security and safety management of commodity chemical and product information

(76) Inventors: Peter S. Edmondson, Alpharetta, GA (US); James Andrew Speer, Kennesaw, GA (US); Charles Rock, Covington, GA (US); Keith Kelly, Covington, GA (US)

Correspondence Address: SONG K. JUNG, McKenna Long & Aldridge LLP, 1900 K Street, NW, Washington, DC, 20006, US

(21) Appl. No.: 10/290,319

(22) Filed: Nov. 8, 2002

(51) Int. Cl. G06F 17/00

(52) U.S. Cl. 707/101

(57) ABSTRACT

A security database is provided that receives commodity activity elements in a predetermined format from activity data sources. The commodity activity elements relate to commodity chemicals, commodity products, their inert/active ingredients, and their related events (e.g., the registration, licensing, application, manufacture, disposal, transportation, etc.). Matching logic within the security database is capable of enabling commodity activity elements from one activity data source to be mapped to, or associated with, commodity activity elements from the same or different activity data source. The commodity activity elements may be queried, tabulated, viewed for analysis and monitoring of the events related to the commodity chemicals and commodity products.

### BACKGROUND OF THE INVENTION

1. Field of the Invention

The present invention relates generally to the field of agriculture and more particularly to a method and system for managing agricultural information, and for monitoring the sale, distribution, and use of agricultural products, including pesticides, fertilizers, livestock, produce, food and water products as it pertains to the potential for security and safety analyses.

2. Discussion of the Related Art

Recently, a great deal of attention has been placed on the threat of biological terrorism through the introduction of biological agents such as anthrax or smallpox. While biological terrorism is of grave concern, equally important is the potential for accidental or inappropriate use of chemicals and other products generally associated with the production, distribution, storage, sale, manufacture, and formulation, etc., of chemicals and products used in commodity industries; also the accidental or inappropriate use of plant and animal diseases and their spread.

The nation's food and water supply chains represent a significant source for potential devastation to large numbers of people, livestock, fish, various commodities, fresh or processed foods, etc. These supply chains are complex systems that are dependant upon numerous products, personnel, practices, and processes for the efficient production of commodities (e.g., crops, livestock, etc.). One category of products, agricultural chemicals, while varying in their toxicology profiles may pose local or national threats if used or handled inappropriately or if exposures occur at unsafe levels. Members of communities involved in the production, distribution, application, and sale of commodities (e.g., agricultural, mining communities, etc.) are aware of the safety and security issues inherent in the industry and understand the importance of regulating the production, distribution, sale, and use of many of these inputs.

As a result, the agricultural community understands the importance of regulating products and their production and distribution chain together with the various practices and activities that support the industry. In order to protect the environment and general public, Congress has authorized certain government agencies, including EPA, FDA, and USDA, to create and enforce regulations related to agrichemical products, livestock, poultry, fish, other foods, processing and handling establishments and commodities, and sellers and buyers of these agricultural products. These products, practices, and activities and their respective uses/users are regulated to one degree or another by both state and federal law. The EPA may regulate pesticides by developing and implementing policies which require testing to assess pesticide safety, as well as requiring registration and proper labeling of pesticides.

States often further regulate the sale and use of agrichemical products and have the responsibility of performing inspection and enforcement activities. Many products and businesses (fertilizers, dealers, applicators, and Pest Control Operators (PCOs)) are not directly federally regulated, which allows the states great latitude in how regulations are developed and enforced. In many cases, states have the authority to require and request more data than is currently requested or has been tracked in the past on agrichemical products and individuals using them. Different states often have their own procedures for approval and registration of pesticide products. Also, various states require all dealers and applicators to be licensed for certain state restricted use pesticide (S-RUP) products and state limited use products (SLUP). SLUP includes products which may be legally purchased and used in small quantities (e.g., 16 oz or less), but which require a license to be purchased and used in large quantities. There are also special local need (SLN) products which are pesticides intended to address a specific crop or problem in a specific area and which may, if used improperly, present a serious threat to public health and/or the environment. S-RUP and SLN products may not be legally sold to or used by unlicenced individuals within these states.

Also, for certain restricted use pesticide (RUP) products, the federal government requires each state to license all dealers and applicators. RUP products may not be legally sold to or used by individuals who are not licensed or certified. Similarly, RUP products may only be sold within a state by a dealer which has been licensed in the state. Generally, these RUP products include pesticides intended for widespread agricultural or industrial use and which may, if used improperly, present a serious threat to public health and/or the environment.

Coupled with state and federal regulation, an equally important enforcement resource exists within the states. This resource consists of numerous, well-qualified field inspectional/investigational support staff members having varying levels of assignment and responsibilities. State field inspectors perform numerous types of inspection activities, such as dealer business records inspections, use investigation reports, product sample investigations (samples of products that are analyzed in a lab to verify consistency with labeling specifications), and product registration validations. Food handling establishments are routinely inspected, water sources are sampled, certain goods that are imported and/or exported are often very thoroughly inspected and monitored.

Regulations requiring registration of products or licensing of dealers and applicators does help insure a degree of security, however the existing state registration, licensing, and inspection systems are generally independent from one another, creating challenges in assessment of risk potential and communication between enforcement interests. The current process of licensing applicators, dealers, and products in each state coupled with the field support creates an extensive security risk potential. Consider just one restricted use pesticide (RUP), Phostoxin, manufactured by Degesch America, Inc. Phostoxin is a fumigant pesticide product used to protect animal feeds, processed food commodities, and non-food commodities (tobacco). Phostoxin is typically used within a controlled space such as a grain bin, warehouse, or some other storage area. Phostoxin has an inert/active ingredients of Aluminum Phosphide and is available workingly in tablets, pellets, powders in a bag or envelope. The pesticide product is a solid dark gray material that reacts when exposed to moisture or water. When introduced to water, the product releases a deadly gas called hydrogen phosphide (phosphine) gas.

Phosphine gas has an odor similar to garlic and may not be readily detected under certain circumstances; the absence of a garlic odor does not mean that dangerous levels of phosphine gas are absent.

Mild inhalation exposure to phosphine gas causes malaise (indefinite feeling of sickness, ringing of ears, fatigue, nausea, and pressure in the chest). With mild exposure, the symptoms of poisoning may take up to 24 hours to appear. Moderate exposure will causes weakness, vomiting, and pain just above the stomach, chest pain, diarrhea and dyspnea (difficulty in breathing). Severe poisoning may occur within a few hours to several days, resulting in pulmonary edema (fluid in lungs) and may lead to dizziness, cyanosis (blue or purple skin color), unconsciousness, and death.

In sufficient quantity, phosphine affects the liver, kidneys, lungs, nervous system, and circulatory system. Inhalation can cause lung edema (fluid in lungs) and hyperemia (fluid in brain). Ingestion can cause lung and brain symptoms, but damage to the viscera (body cavity organs) is more common. Phosphine poisoning may result in (1) pulmonary edema, (2) liver elevated serum glutamyl oxaloacetic transaminase (GOT), LDH and alkaline phosphatase, reduced prothrombin, hemorrhage and jaundice (yellow skin color) and (3) kidney hematuria (blood in urine) and anuria (abnormal lack of urination). Pathology is characterized by hypoxia (oxygen deficiency in body tissue). Frequent exposure to subacute concentrations over a period of days or weeks may cause poisoning.

In addition to the inhalation or ingestion risks, phospine gas may ignite spontaneously in air at concentrations above its lower flammable limit of 1.8% (v/v).

Due to the high inhalation toxicity of Phostoxin, it is a restricted use product (RUP). Phostoxin may only be sold to someone who has a dealer's license or applicator credential and should only be used by individuals that are certified applicators or working under their direct supervision. This means that any dealer or applicator must have a state license to purchase/sell or apply the product. While this does go a long way towards preventing the product from getting into the wrong hands, the license and registration process is driven by an individual competency standard with little to no emphasis on national security interests. When applying for a license, most states have no provision for individual background checks. In many states, an individual can acquire a license or certification by filling in an application, passing a test, and submitting a fee. When the product is sold, a dealer is often not required to report the purchase of Phostoxin, though sales records are required to be kept. Currently there is no means by which a dealer can verify that a potential purchaser has supplied a legitimate business or applicator license. Internet sales options to purchase goods and services present added challenges as the buyer and/or the seller can be anonymous. In this scenario, e-commerce vendors generally lack the ability to verify dealer or applicator licenses and product registration status within states.

Currently there are ninety two (92) products under different brand names registered with the EPA that contain the same active ingredient found in Phostoxin (Aluminum Phosphide); there are more than twelve hundred (1200) registered pesticide products that the EPA considers dangerous enough to classify as RUPs. This figure only includes pesticide products; the terrorist attack in Oklahoma City, Okla. demonstrated the potential hazard associated with fertilizers, which are only regulated at the state level.

Consider all of the facts: RUPs such as Phostoxin are easily acquired. Taking Phostoxin as an example, the product is produced in a pellet or granular form that is easily transported. The only ingredient required to produce a highly toxic gas is water, which is readily available anywhere. An individual could easily acquire massive amounts of Phostoxin without raising suspicion by purchasing the product from multiple dealers or in multiple states or through multiple web sites.

If a restricted use product, such as Phostoxin, were used by an individual or individuals, either knowingly or unknowingly inflicting harm on other individuals or the environment, how would local, state, and federal agencies react or even plan for the possibility of such damage? Due to the fact that pesticide and license regulations occur on a state-by-state basis, where would authorities turn to find information when response times are critical? How would authorities compile a list of possible suspects?

The U.S. food and agricultural system currently accounts for about 13% of the U.S. Gross National Product (GNP) with one eigth of all American jobs connected to agriculture, either directly or indirectly. From the farm to the table, control of industrial, commercial, and agricultural activities by means of international, federal, state, and local laws, regulations, statutes, ordinances is endemic. According to a report by the Animal and Plant Health Inspection Service (APHIS), a division within the USDA, at the 2001 American Veterinary Medical Association Convention, there are approximately 150 foreign animal diseases APHIS is concerned with keeping out of the United States. On an average day, 1.3 million people enter the country, along with 38,000 animals. In fiscal year 2000, 14 million animals were imported, mostly from Mexico to Canada.

The World Organization for Animal Health or Office International des Epizooties (OIE) is an intergovernmental organization with 155 member countries that is the international body responsible for setting animal health standards on which international trade restrictions are based. Transmissible diseases under the OIE classifications have the potential for very serious and rapid spread, serious socio-economic or public health consequences and are of major importance in the international trade of animals and animal products.

In 1997, an outbreak of Classical Swine Fever in the Netherlands left $2.3 billion (USD) in economic damages and 8 million hogs destroyed. Also, in 1997, an outbreak of Foot and Mouth Disease (FMD) spread rapidly in Taiwan, causing some 8 million hogs to be destroyed and $8 billion (USD) in economic losses. In the spring of 1999, dioxin (cancer causing lipid soluble polychlorinated/brominated dibenzo-p-dioxins) was introduced into the Belgian food supply, including exports, via contaminated animal fat used in animal feed supplied to Belgian, French, and Dutch farms. Hens, pigs, and cattle ate the contaminated feed and high levels of dioxin were found in meat products as well as eggs. Within two to three weeks following the first announcement of contamination, at least 30 countries temporarily banned imports of Belgian agriculture products. Some countries banned imports from France, the Netherlands, and Germany as well. The United States went one step further and temporarily banned all European poultry and pork imports.

The existing process of regulating and monitoring products, practices, or individuals is time consuming and error prone. The existing process involves the registration, licensing, or inspection of various products, businesses, or individuals, with various federal, state, and local agencies that seldom interact with each other. Even within a particular state, various departments and divisions do not effectively communicate with each other. For instance, many states regulate both pesticides and fertilizer products within different departments. These departments typically are physically located together with state employees often sitting just a few feet away from each other. In many instances, states are still using legacy hardware and software systems that were developed as many as 15 years ago. Because of budgetary restrictions or the lack of qualified maintenance personnel, these systems are rarely updated to reflect changes in policy or regulations and the systems no longer adequately meet the state's needs.

Currently inspectors and enforcement staff are required to research products or individuals through massive stacks of paper printouts that contain lists of names (products, business and individuals). These bulky piles of paper are carried into the field and are out-of-date within hours of being printed. Due to the enormous cost of printing and composing these lists, the printouts are generally only produced on a reoccurring schedule that may involve weeks or months before the list is reproduced.

Furthermore, state Departments of Agriculture lack the ability to optimize inspection routes and fully plan for an inspector's time in the field. Consequently the inspector's time is underutilized, poorly planned and each individual inspection requires a significant amount of time. Inspectors are seldom trained to notice other irregularities, such as diesel storage tanks near ammonium nitrate drums, requiring other staff to visit the same locations for inspectional activities.

Should an inspection reveal that enforcement activities are required, an inspector is currently required to write an inspection record on paper forms. Because inspections are usually performed regionally, it may be days or weeks before the data from the inspection activity is entered into a department's computer systems. This process of data entry after the fact is error prone and delays the process of actually performing the inspection. In addition, the quality of the data may be impaired due to error in reading handwriting, transposing characters, missing information that should be mandatory, incorrect spelling, etc.

A few states have started adopting technology (usually laptop computers) to improve the process. These states have developed custom software to allow an inspector to query products or enter inspection data. The data is then synchronized on a regular schedule. While this solution does provide some cost saving from the standpoint of producing paper reports and data entry, the inspectors have found that laptop computers are too bulky to be used in the field. Due to the harsh conditions that inspectors encounter in warehouses, feed-mills, etc., laptop computers are not the optimal solution, and frequently laptop computers are damaged in the field or the inspector decides not to utilize the laptop computer and enters data after returning to an office at a later time. The end result is that the laptop computers are not used as they were intended. There is still no communication among different states or different agencies within the same state.

Properly implementing and exercising authoritative rights on regulations requires a great deal of time and expense. Out of date systems must be updated or new systems must be built. Because of the time and expense required to update or create tracking systems, a great deal of information is missed. For instance, pesticide dealers are required to keep records on the sales of Restricted Use Products (RUPs). These records must indicate to whom a product was sold and how much of the product was sold. Currently dealers do not have to report this information to state Departments of Agriculture. The dealer must simply have these records available for inspection by state enforcement staff, if requested, which seldom happens.

In the case of individuals who are being licensed to sell or use various chemicals, states frequently do not implement background checks to ensure that a potential licensee is in fact eligible for a license. Many times, licenses, permits and certifications are granted whenever someone simply fills out an application and pays an appropriate registration fee.

In an effort to better serve their constituents, many states have adopted their own internal policies for moving their state into the realm of “e-government;” typically Departments of Agriculture will be the least understood, the least publicly visible, and therefore get the least attention of statewide upgrades. These state agencies lack the ability to share data amongst other states and enforcement agencies. Ultimately, hundreds of various federal, state, and local governmental agencies will regulate thousands of products, practices and services, with no consolidation or sharing of data.

It was this understanding and recognition of the problems related to regulation, licensing, application, and inspection, within the agricultural community today that formed the impetus for the present invention. The lack of any ability to predict potential threats to the safety of our national food and water supply, or to monitor people and products on a continent-wide basis, provided the motivation to move toward a centralized data-warehouse that would not change state's current activities, but would pool their information for the benefit of safety and security analysis.

Accordingly, the principles of the present invention are directed toward an improved security system capable of managing information related to identification, tracking, inspection, registration, licensing, authentication, mapping, and data distribution of agricultural products used in the production, distribution, etc. of commodities (crops, livestock). Other and further advantages will appear hereinafter.

### SUMMARY OF THE INVENTION

Accordingly, the present invention is directed to agricultural security and safety using agricultural information that substantially obviates one or more of the problems due to limitations and disadvantages of the related art.

An advantage of the present invention is to provide alerts and warnings to local, state and federal authorities about the potential for misuse, theft, storage of dangerous chemicals.

Another advantage of the present invention is to provide timely information (such as MSDS's) to safety officials in the identification and cleanup of hazardous chemicals.

Another advantage of the present invention is to provide numerous levels of security of data to allow access to subsets of data as appropriate using various authentication methods (passwords, biometrics), to ensure the privacy of personal and business data, protect sensitive and confidential data from theft or alteration.

Another advantage of the present invention is to provide pre-emptive alerts via electronic mail (email), cellular phone or pagers or other wireless device to authorities the moment that an event is triggered, without security authorities having to sift through tons of reports to look for irregularities.

Another advantage of the present invention is to provide a national identification system (using various barcode symbologies, microdots, DNA, biometrics, and other emerging technologies) for the identification and tracking of livestock and other products, from cradle to grave (e.g., from the birth of a calf to the packaged meat on a grocery store shelf).

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a method organizing data elements within a database includes providing a first plurality of data elements to a database, wherein at least one first association exists between at least two of the data elements of the first plurality of data elements; providing a second plurality of data elements to the database, wherein the second plurality of data elements are different from the first plurality of data elements; and determining whether the at least one association exists between at least one of the second plurality of data elements and at least one of the at least two data elements of the first plurality of data elements.

In another aspect of the present invention, a system for organizing information related to commodity chemicals and commodity products includes a security database for storing a plurality of commodity activity elements; a plurality of activity data sources for submitting the plurality of commodity activity element sets, wherein each of the commodity activity element sets comprises the plurality of commodity activity elements; and matching logic for determining whether an association exists between predetermined commodity activity elements in predetermined ones of the plurality of commodity activity element sets.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the relationships of various data structures and activity data sources within the security database according to the principles of the present invention.

FIG. 2 illustrates an exemplary process flow in a regulatory reporting process involving an applicant for a license in accordance with the principles of the present invention.

FIG. 3 illustrates an exemplary process flow in a document receipt, submission, conversion, and approval process in accordance with the principles of the present invention.

FIG. 4 illustrates an exemplary process flow in a submission process involving universal product code (UPC) in accordance with the principles of the present invention.

FIG. 5 illustrates an exemplary process flow in a document review/approval process in accordance with the principles of the present invention.

FIG. 6 illustrates an exemplary process flow in a renewal process in accordance with the principles of the present invention.

FIG. 7 illustrates an exemplary process flow in an inspection reporting process according to the principles of the present invention.

FIG. 8 illustrates a matching process in accordance with the principles of the present invention.

FIG. 9 illustrates a data association process based on results of the matching process in accordance with the principles of the present invention.

FIGS. 10A-H illustrates exemplary relationships between different database within the security database according to the principles of the present invention.

### DETAILED DESCRIPTION OF THE ILLUSTRATED EMBODIMENTS

Reference will now be made in detail to embodiments of the present invention, examples of which are illustrated in the accompanying drawings.

The security system according to the principles of the present invention facilitates archiving, analysis, and manipulation of data contained within a security database.

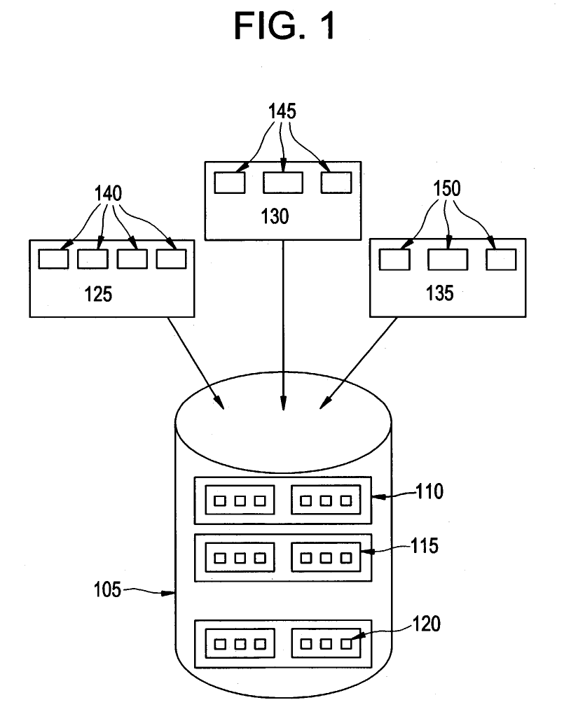

FIG. 1 illustrates various groups of information and activity data sources according to the principles of the present invention.

Referring to FIG. 1, the security database 105 may generally store a plurality of aggregate commodity activity element sets 110, wherein each aggregate commodity activity element set further comprises a plurality of commodity activity element sets 115 that are interrelated to each other in various ways (as indicated by the arrows). The commodity activity element sets further comprise a plurality of commodity activity elements 120, provided by activity data sources, that are also interrelated with each other (as indicated by the arrows). Commodity activity elements may, for example, include descriptive data falling within the purview of any local, state, federal, and international regulatory and compliance enforcement entities. For example, commodity activity elements may include descriptive data related to environmental health and safety (Titles 7, 10, 29, 30, 40, 42, and 49 of the Code of Federal Regulations and related state and local codes); agricultural activities (Titles 7 and 9); working trade practices (Title 16); food, drugs, cosmetics, medical treatments and devices (Title 21); transportation of cargo (Title 49); mining and related activities (Title 30); activities in and on parks, forests, public lands and other public property (Titles 36 and 43); public health (Title 42); emergency management and assistance (Title 44); and wildlife and fisheries activities (Title 50). Accordingly, the security database may be used to provide a security system capable of detecting trends in events related to, and effects of, production, distribution, sale, application, storage, disposal, etc., of commodity chemicals, commodity products, and/or their inert/active ingredients.

Accordingly, commodity activity elements may represent data related to any of a commodity product or commodity chemical, their active/inert ingredients, and/or their related events (i.e., services, registration, licensing, regulation, production, manufacture, formulation, storage, distribution, disposal, sale, application, certification, , etc.).

In one embodiment of the present invention, commodity chemicals may include agrichemicals, chemicals used in mining operations, gasoline or other types of fuel, or any other chemical used in the production, distribution, and/or disposal of commodity products. Commodity products may, therefore, include livestock, crops, fruits, vegetables, feed, seed, minerals, lumber, seafood, or any other article of trade that may be further processed and/or resold.

In one aspect of the present embodiment, agrichemicals may include chemicals and other products such as hormones, drugs, fertilizers, nutrients, fungicides, herbicides, insecticides, or any other pesticide, agricultural liming material, or other substance used to selectively promote the health, survival, and/or production of commodity products. Further, a pesticide may also include substances or mixtures of substances intended for use as plant regulators, defoliants, desiccants, and the like.

In another aspect of the present embodiment, chemicals used within mining operations include explosives, leaching solvents, and the like that perform functions of primary ore extraction, ore enrichment, and various other reagents that facilitate froth floatation, hydrometallurgy, recovery of valuable mineral components, etc. The use of commodity chemicals in mining operations also extends to functions such as storage, handling, and transportation of minerals.

In one embodiment of the present invention, diverse types of data may be included within different commodity activity elements; these elements may suitably originate from information provided by hard copies or electronic representations of certificates, labels, licenses, registrations, sales/inventory records, usage reports, application reports, manufacturing reports, surveys, field testing/analysis, bar code identification/tracking, and the like. To facilitate handling of data provided by the commodity activity elements, these elements may be broadly and conceptually classified as they relate to a particular type of information.

In one aspect of the present embodiment, commodity activity elements used in the description of actual commodity chemicals and/or their inert/active ingredients (e.g., physical/chemical properties, package attributes, etc.) may be characterized as commodity chemical information. Commodity activity elements used to identify activity data sources may be characterized as identity information. Commodity activity elements used to identify the consumption (e.g., the use, mixture, reaction, application, etc.), of commodity products, commodity chemicals, and/or their inert/active ingredients by producers or technicians, as will be discussed in greater detail below, may be characterized as consumption information. Commodity activity elements related to transfer of possession, ownership, jurisdiction, etc., of a commodity product, a commodity chemical, and/or its inert/active ingredients may be characterized as transaction information. Commodity activity elements related to a qualitative or quantitative measurement of a commodity product, a commodity chemical, its inert/active ingredients, unit/package attributes, its adherence to a state-approved label, its sample characteristics (e.g., physical and chemical properties), and/or the effects of its interaction within a predetermined environment or commodity activity location, as will be discussed in greater detail below, may be characterized as inspection information. Commodity activity elements related to the production (e.g., manufacture, formulation, generation, and processing, etc.) of a commodity product, commodity chemical, and/or its inert/active ingredients by a producer may be characterized as production information. Commodity activity elements used to describe commodity activity locations (e.g., sites or environments specific to the production, transfer, disposal, storage, distribution, application, etc., of commodity products, commodity chemicals, and/or their inert/active ingredients) may be characterized as location information. Commodity activity elements used in the description of actual commodity products (e.g., commodity product name, unit attributes, etc.) may be characterized as commodity product information. Commodity activity elements used in the description of the state of health of or disease of a commodity product may be characterized as health information.

In the present aspect of the invention, commodity chemical information further includes commodity activity elements related to an actual commodity chemical and/or its inert/active ingredients. Accordingly, commodity activity elements classified as commodity chemical information may describe a trade name, unique identification (e.g., UPC, EPA ID, etc.), approval status, MSDS information such as registrant information, emergency phone numbers, active/inert ingredients (hazardous/non-hazardous), physical/chemical characteristics (e.g., boiling point, specific gravity, vapor pressure, vapor density, melting point, evaporation rate, solubility in water, appearance and odor, etc.), fire and explosion hazard data (e.g., flash point, flammability limits, extinguishing media, special fire fighting procedures, unusual fire and explosion hazards, etc.), reactivity data (e.g., stability, incompatibility, hazardous decomposition, hazardous polymerization, conditions to avoid, etc.), health hazard data including routes of entry (e.g., inhalation, skin, ingestion, etc.), acute/chronic, signs, symptoms of exposure, etc., precautions for safe handling and use steps if material is released or spilled precautions for handling & storage, other precautions, etc., control measures (e.g., respiratory/eye protection, protective gloves, clothing/equipment, work/hygenic practices, etc.), version date, etc., and label information (e.g., directions for use, precautionary statements describing potential hazards to humans and pets and actions that may be taken to reduce those hazards, environmental hazards, physical or chemical hazards, storage and disposal information, first aid instructions, formulation of active/inert ingredients, warranty/liability statements, manufacturers address, net weight/net contents statement, EPA ID number for the commodity chemical, EPA establishment number, etc.), wherein appropriate units of measure may be included.

In the present aspect of the invention, commodity product information further includes commodity activity elements related to an actual commodity product and/or its inert/active ingredients. Accordingly, commodity activity elements classified as commodity product information may describe a trade name, unique identification (e.g., UPC, EPA ID, etc.), approval status, physical/chemical characteristics, health hazard data, and label information, formulation of active/inert ingredients, warranty/liability statements, manufacturers address, net weight/net contents statement, etc., wherein appropriate units of measure may be included.

In the present aspect of the invention, identity information further includes commodity activity elements related to an identity of an individual or organization licensed, registered, applying, storing, disposing, selling, distributing, producing, etc., a commodity product, a commodity chemical, or ingredients thereof. Identity information may also include commodity activity elements related to an identity of an individual or organization supplying commodity activity elements to the security database, as will be discussed in greater detail below. Accordingly, commodity activity elements classified as identification information may describe a name, individual/organizational ID unique to the particular activity data source, registration number, license number, phone number, username/ID, or password or the like, of the aforementioned identity information subjects.

In the present aspect of the invention, production information further includes commodity activity elements related to the production (e.g., its manufacture, formulation, generation, processing, etc.) of a commodity product, a commodity chemical, and/or its inert/active ingredients. Accordingly, commodity activity elements classified as production information may, for example, describe a quantity and rate of production of, along with unit attributes (e.g., size, weight, etc.), of any of the aforementioned production information subjects produced.

In the present aspect of the invention, consumption information further includes commodity activity elements related to the consumption of a commodity product, a commodity chemical, and/or its inert/active ingredients in the production of another commodity product, commodity chemical, and/or its inert/active ingredients or in the application of a commodity product/chemical towards a pest by an operator. Accordingly, commodity activity elements classified as consumption information may, for example, describe, as applicable, at least one of an amount of commodity chemical/product/ingredient consumed in the production of a commodity product, a commodity chemical, and/or its inert/active ingredients, rate of consumption, units of measure of amount consumed and rate of consumption, area treated during consumption, units of measure of area treated during consumption, task (e.g., feeding livestock, vaccinating animals, fertilizing fields, applying pesticide, ore enrichment, filling a gas tank, etc.), target (e.g., specific subject of task: cattle, dog, spring planting preparation, grasshoppers, gold, diesel, etc.), time/date of consumption, boundary type (external or line), machine type used in consumption (e.g., tractor, airplane, back pack, hopper, etc.), implement type used in consumption (e.g., sprayer type, nozzle type, granular distributor, etc.), implement width, implement offset, height/depth of commodity product/chemical provided in consumption, environmental conditions during consumption (e.g., sky conditions, wind direction, wind speed, humidity, air temperature, soil temperature, etc.), etc., of any of the aforementioned subjects consumed.

In the present aspect of the invention, transaction information further includes commodity activity elements related to the transaction of a commodity product, a commodity chemical, and/or its inert/active ingredients. A transaction may include the transfer of ownership, possession, control, jurisdiction, etc., of any of the aforementioned transaction information subjects. Accordingly, commodity activity elements classified as transaction information may describe a quantity, unit size, number of units, or time/date of transaction of any of the aforementioned transaction information subjects involved in a transaction.

In the present aspect of the invention, inspection information further includes commodity activity elements related to the inspection of a commodity product, a commodity chemical, and/or its inert/active ingredients, within a commodity activity location, by an inspector. Accordingly, commodity activity elements classified as inspection information may describe quantity, unit size, number of units, concentration, subject of inspection, effects of their interaction with an ecosystem (e.g., warehouse, disposal facility, truck, soil, water, air, organisms, etc.), or time/date of inspection of any of the aforementioned inspection information subjects involved in an inspection.

In the present aspect of the invention, location information includes commodity activity elements related to a commodity activity location spatially defining, up to a predetermined spatial resolution, a physical location of a transaction, storage facility, disposal site, application site, inspection site, production area, distribution routes, drainage areas, registrations, licensing, and other event locales, in addition to locations of registrars, licensers, registrants, licensees, applicants, all involved with a commodity product, a commodity chemical, and/or its inert/active ingredients. The predetermined spatial resolution may be defined in terms of any of the specific areas or ranges of areas where the aforementioned location information subjects may be found. For example, commodity activity locations may be defined in terms of a mailing address, a computer address, an elevation, a population density of humans or of a predetermined type of livestock, soil cultivation density, ecosystem type, soil type, crop type, livestock type, pest type, mineral type, country, state/province, county/municipality, EPA region, latitude, and longitude, manufacturing site, transaction site, transportation route, storage site, application site, disposal site, watersheds, bodies of water, predetermined amount of rainfall, etc., or combinations thereof.

In the present aspect of the invention, health information further includes commodity activity elements related to a diagnosis of a state of disease (e.g., a pathological condition of a part, organ, or system of a commodity product resulting from causes such as infection, genetic defect, or environmental stress, and characterized by an identifiable group of signs or symptoms) of a commodity product within a commodity activity location, by a technician. Accordingly, commodity activity elements classified as health information may describe at least one of time/date of diagnosis, type of disease (e.g., bacterial, viral, etc.), specific disease, cause, symptoms, etc., of any of the aforementioned commodity products.

Conventional reporting processes related to environmental, agricultural, or mining events, etc., (e.g., licensing, registration, application, sale, distribution, consumption, production, etc.) frequently feature a delay of weeks or even months from the time data are reported to the time when the data are accessible for “secondary use”, i.e., use by anyone other than the recipient of the original report, usually a hard copy version. This delay is a major factor in the duplication and other inefficiencies that characterize agricultural and mining reporting, and undermine public trust, and environmental, agricultural, and national security.

Referring to FIG. 1, the security system of the present invention includes a security database 105 containing information derived from commodity activity elements generated by activity data sources. As will be discussed in greater detail below, information stored within the security database may be accessible to users (e.g., regulators, industry, academics, environmentalists, general public, etc.) depending on a predetermined user authorization, while simultaneously providing secure information to emergency and security authorities for the analysis of security and safety efforts.

In one embodiment of the present invention, activity data sources generally represent the source from where all commodity activity elements are submitted to the security database.

In one aspect of the present embodiment, all of the aforementioned commodity activity elements generated by activity data sources may be reported to the security database. To facilitate management of the diverse commodity activity elements generated by various activity data sources, these sources may be broadly classified as they relate to a particular source of information.

In one aspect of the present embodiment, activity data sources may, for example, broadly be classified into governmental regulatory activity data sources 125, working activity data sources 130, and third-party activity data sources 135, depending from which activity data source the commodity activity elements are generated.

In the present aspect of the invention, governmental regulatory activity data sources may include, for example, local, state, federal, and international regulatory activity data sources 140.

Local regulatory activity data sources may, for example, include locally or municipally run agricultural/structural/environmental regulatory or compliance organizations, etc.; state regulatory activity data sources may, for example, include state run and/or supported agricultural/structural/environmental regulatory or compliance offices such as various state departments of Fish and Game, state Departments of Agriculture (DOA), and the like; federal regulatory activity data sources may, for example, include the Food and Drug Administration (FDA), Environmental Protection Agency (EPA), Department of Environmental Conservation (DEC), Center for Disease Control (CDC), United States Department of Agriculture (USDA), and the like; and international regulatory activity data sources may, for example, include the World Health Organization (WHO), United Nations (UN), North Atlantic Treaty Organization (NATO), and the like, in addition to other locally, regionally, and nationally based levels of regulatory activity data sources of various countries around the world.

Commodity activity elements accumulated by the security database originating from local regulatory activity data sources may include identity information, commodity chemical information, commodity product information, location information, production information, and/or consumption information. Identity information supplied by local regulatory activity data sources may, for example, include identity of the local regulatory activity data source; identity of an applicator, identity of the wholesaler; identity of the producer, wholesaler, and other such entities associated in one way or another with commodity products, commodity chemicals, and/or their inert/active ingredients. Commodity chemical, commodity product, location, consumption, and/or production information may, for example, include information submitted for licenses (e.g., buying, selling, mining, transportation, application, grading, export, import, etc.), registrations (e.g., of commodity chemicals, mineral sites, etc.), certificates (e.g., phytosanitary import/export, MSDS), and/or in compliance to regulations enforceable within the jurisdiction of the particular governmental regulatory activity data source.

Commodity activity elements accumulated by the security database originating from state and federal regulatory activity data sources may include similar or corresponding information described above with respect to commodity activity elements originating from local regulatory activity data sources and may also include inspection information.

Commodity activity elements accumulated by the security database originating from international regulatory activity data sources may include similar or corresponding information described above with respect to the abovementioned regulatory data sources and may also include information generated during importing/exporting of commodity products, commodity chemicals, and/or their inert/active ingredients.

In the present aspect of the invention, working activity data sources 130 may broadly include, for example, producer, wholesaler, distributor, retailer, and technician activity data sources 145.

In one aspect of the present invention, producers may, for example, be further classified as chemical producers and product producers. Accordingly, chemical producers may, for example, include manufacturers and/or formulators of commodity chemicals. Accordingly, manufacturers may, for example, include individuals and/or organizations that manufacture commodity chemicals and/or inert/active ingredients found in commodity chemicals for the purpose of either selling that commodity chemical or ingredient under a unique label or using the inert/active ingredients in the manufacture of a commodity chemical. Formulators, on the other hand, include individuals and/or organizations that formulate or have formulated for it, commodity chemicals from manufactured inert/active ingredients. Thus, for purposes of the present invention, a commodity chemical may be produced if it is at least manufactured and/or formulated.

Product producers, on the other hand, may, for example, include generators and/or processors of commodity products. Accordingly, generators may, for example, include, breeders of livestock, organic and non-organic farmers, apiaries, wineries, lumber mills, or any other individual or organization capable of generating a commodity product originally provided in either a raw or essentially chemically unaltered form into either a final form for sale, distribution, storage, etc., or in an intermediary form that may be further processed or packed for distribution, storage, distribution, application, sale, etc. Accordingly, processors include any individual or organization involved in processing or packing commodity products provided in an intermediary form to a final form suitable for distribution, storage, application, sale, etc. Accordingly, processors may, for example, include paper mills and processors, food processors, seafood packers/processors, feed mills, feed lots, etc.

Wholesalers include entities that sell commodity products and/or commodity chemicals to retailers.

Retailers include entities that transfer ownership of, or title to, commodity products and/or commodity chemicals to producers, technicians, and the like. Commodity products or commodity chemicals transferred by retailers may be used only, e.g., they may not be used for resale in any unaltered form.

Distributors include any individual and/or organization (warehouse, transfer/receiving stations, etc.) involved in storing and/or moving commodity products, commodity chemicals, and/or their inert/active ingredients between commodity activity locations within one working activity data source, between two or more separate working activity data sources, and/or across borders of importing/exporting countries.

Technicians include any individual and/or organization (e.g., structural pest control operators, veterinarians, veterinary technicians, kennels, animal shelters, impounds, commodity chemical disposal technicians, etc.) involved in the application of any commodity chemicals and/or commodity products toward pests (e.g., insects, plants, microorganisms, etc.), and animals. Further, technicians may include any individual and/or organization not directly involved in the production of a commodity product to be further processed and/or sold in commerce. Still further, technicians may not be involved in the disposal and distribution of commodity products, commodity chemicals, and/or their active ingredients.

Commodity activity elements accumulated by the security database originating from producers may include at least one of the identity information of the producer, commodity product and chemical information of the commodity product/chemical being produced (e.g., manufactured, formulated, generated, or processed), transaction information, production/consumption information, location information, and any other information derived from compliance with any past, present, and future, local, state, and federal regulations (e.g., information derived from commodity chemical/product production, storage, disposal, distribution, registration/licensing, renewals, usage reports, etc.) relevant to producers.

Commodity activity elements accumulated by the security database originating from wholesalers may include information related to at least one of the identity information, transaction information, location information, commodity product information, commodity chemical information, consumption information, and any other information derived from compliance with any past, present, and future, local, state, and federal regulations (e.g., information derived from commodity chemical/product, storage, disposal, distribution, registration/licensing, renewals, use reporting, etc.) relevant to wholesalers.

Commodity activity elements accumulated by the security database originating from retailers may include information related to at least one of the identity information, commodity product information, commodity chemical information, transaction information, location information, application information, and any other information derived from compliance with any past, present, and future, local, state, and federal regulations and licensing requirements (e.g., information derived from commodity chemical/product, storage, disposal, distribution, sales, registration/licensing, renewals, sales reports, etc.) relevant to retailers.

Commodity activity elements accumulated by the security database originating from distributors may include information related to at least one of the identity information, commodity product information, commodity chemical information, transaction information, location information, consumption information, and any other information derived from compliance with any past, present, and future, local, state, and federal regulations and licensing requirements (e.g., information derived from commodity chemical/product, storage, disposal, distribution, registration/licensing, renewals, transportation records, storage certificates, etc.) relevant to distributors.

Commodity activity elements accumulated by the security database originating from technicians may include information related to at least one of the identity information, location information, commodity product information, consumption information, and commodity chemical information, and any other information derived from compliance with any past, present, and future, local, state, and federal regulations (e.g., information derived from commodity chemical/product, storage, disposal, distribution, registration/licensing, renewals, etc.) that is relevant to technicians.

In the present aspect of the invention, third-party activity data sources 135 may broadly include non-profit (e.g., “watch dog”, “grass roots” organizations, etc.), engineering environmental cleanup, survey center activity data sources 150, and the like that generate commodity activity elements including information related to at least one of identity information, commodity product information, commodity chemical information, location information, and inspection information in areas defined by any of the aforementioned commodity activity locations.

In order to provide relevance to information within the commodity activity elements, activity data sources interrelate the generated commodity activity elements within a commodity activity element set. For example, commodity activity elements generated by a particular activity data source may generally include, for example, identity, commodity chemical, location and consumption information. Accordingly, an exemplary commodity activity element set may contain interrelated data indicating the name of the consumer (e.g., farmer), a trade name of commodity chemical applied, time of application, date of application, applicator license number, etc. Commodity activity element sets generated by activity data sources are reported to the commodity activity database using an security reporting process, as will be discussed in greater detail below.

Generally, activity data sources provide commodity activity element sets to the security database in security reporting processes. Security reporting processes may generate commodity activity element sets using reporting forms for accumulation by the security database. Using reporting devices, security reporting processes may be initiated by reporting agents representing any of the aforementioned activity data sources.

In one aspect of the present invention, reporting agents representing governmental regulatory activity data sources may, for example, include applicants for licenses, registrations, certificates, etc., registrars, licensers, inspectors, and the like. Reporting agents representing any of the working activity data sources may, for example, include transaction agents such as providing parties and/or receiving parties, as will be discussed in greater detail below. Reporting agents representing third-party activity data sources may, for example, include inspectors, surveyors, etc. Reporting agents representing producer activity data sources may include the various producers, as mentioned above. Reporting agents representing technician activity data sources may, for example, include technicians as mentioned above.

Commodity activity element sets may be reported to the security database in a predetermined format, definable by the reporting form. The reporting form may be provided by the security database and/or any of the aforementioned activity data sources. During the security reporting process, reporting agents may populate predetermined fields of reporting forms with commodity activity elements, thereby creating commodity activity element sets, wherein each of the predetermined fields corresponds to specific database fields on the security database, as will be discussed in greater detail below. Each of the database fields contains records corresponding to only one type of reportable commodity activity element. As will be discussed in greater detail below, for example, one database field may contain only EPA IDs, another database field may contain only license numbers, another may contain only wind directions, another only activity data source types, etc.

In one aspect of the present invention, the predetermined fields may be populated automatically by the commodity activity elements upon their capture by reporting devices or they may be manually entered by the reporting agent.

In one embodiment of the present invention, the reporting forms may exist as one or more electronic or paper forms containing a plurality of the predetermined fields. Accordingly, the predetermined fields may exist as a plurality of separate input fields, wherein each input field has a fixed correspondence to a single database field. Alternately, one or more of the input fields may have a plurality of selectable correspondences to one or more database fields.

In another embodiment of the present invention, the reporting forms may exist as a transmission sequence of data representing commodity activity element sets. Accordingly, the predetermined fields may exist as a coded data stream capable of providing individual commodity activity elements, ordered within the transmission sequence into corresponding database fields.

In yet another embodiment of the present invention, security reporting processes may include the use of programmed or unprogrammed batch, or real time (e.g., as the commodity activity elements are generated) electronic security reporting processes. Accordingly, the security reporting process may be implemented over any wired or wireless network connection using any standard File Transfer Protocol (FTP) proxy, Simple Mail Transfer Protocol (SMTP) proxy, Hyper Text Transfer Protocol (HTTP) proxy, fax transmission, etc., from one or more reporting devices. A reporting device may, for example, include one or more interconnected personal computer terminals, laptops, dedicated personal computers, internet appliances, personal digital assistants (PDA), flow meters equipped with transmitters/receivers, cellular telephones, GPS devices, or any other device capable of electronically downloading/uploading commodity activity elements to and from the security database or capable generating paper based reporting forms having predetermined fields either populated or unpopulated with commodity activity elements.

In one aspect of the present embodiment, reporting devices may also include any combination of supplemental devices such as bar code readers, GPS systems, chemical analyzers, digital cameras, RF or inductive transmitters/receivers and other such systems capable of receiving, interpreting, and/or transmitting information descriptive of a commodity chemical, a commodity product, their inert/active ingredients, and/or their effects within a commodity activity location to the reporting device.

In another embodiment of the present invention, security reporting processes may employ the use of non-electronic security reporting processes such as postal or other courier type service to provide commodity activity element sets for accumulation by the security database.

According to the principles of the present invention, security reporting processes specific to particular activity data sources may include, for example, regulatory reporting, consumption reporting, inspection reporting, transaction reporting, and production reporting processes.

According to the principles of the present invention, commodity activity elements related to the regulation, licensing, registration, certification, etc., of commodity products, commodity chemicals, their active/inert ingredients, and/or their related events by any of the aforementioned activity data sources, may be reported to the security database in regulatory reporting processes. Thus, reporting forms used in regulatory reporting processes may include predetermined fields that contain commodity activity element sets related to identity-information, location information, commodity product information, and commodity chemical information.

In one embodiment of the present invention, a regulatory reporting process may generally be implemented in at least one of a license and registration application process. Accordingly, an applicant applying for at least one of a license and/or registration review/approval of any of the aforementioned commodity chemicals/products, or related events may act as a reporting agent by populating a reporting form provided as one or more appropriate registration and/or license applications. Additionally, any of the working or technician activity data sources filing any use, production, distribution, storage, disposal, sale, marketing, etc., of any of the aforementioned chemicals and/or products may act as a reporting agent by one or more appropriate forms.

In populating any of the aforementioned reporting forms, the applicant may, for example, report identity, commodity chemical, commodity product, and location information, and any other information as required by registrars, licensers, regulations, of relevant regulatory and/or compliance organizations. For example, commodity activity elements provided by the applicant may generally include applicant's name, permanent/mailing address, what the applicant is applying for, and/or any unique commodity chemical identification.

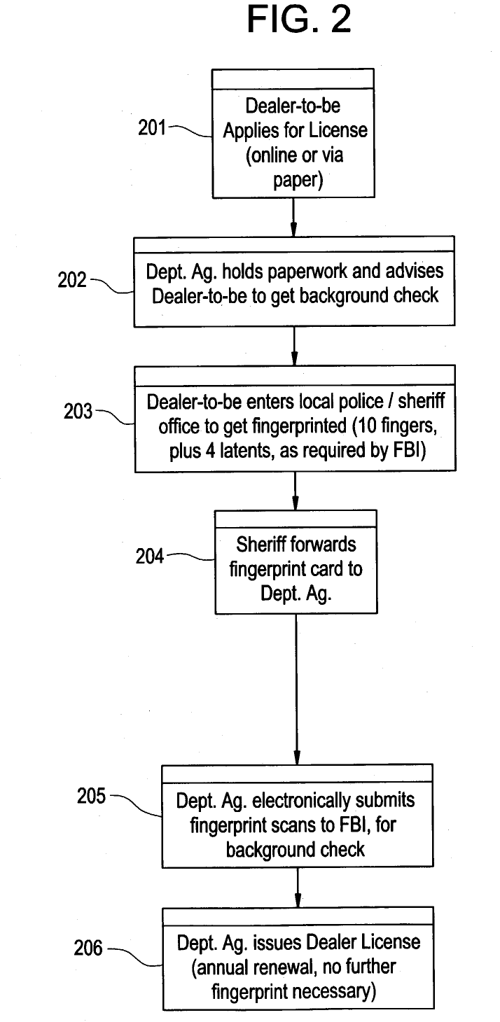

Referring to FIG. 2, in an aspect of the present embodiment, the applicant may, for example, include a retailer, producer, wholesaler, distributor, or the like, applying for a license, registration, certificate, etc., to sell, distribute, purchase, manufacture, formulate, generate, process, consume, use, apply, etc., or otherwise perform in an event involving any of a commodity chemical, commodity product, and/or their active/inert ingredients.

Still referring to FIG. 2, the applicant populates an appropriate license application in step 201. Once completed, the license application may then be held and reviewed by appropriate governmental regulatory activity data sources (e.g., a suitable officer within the Department of Agriculture) in step 202. Subsequently, the officer of the governmental regulatory activity data source may initiate a background check on the applicant prior to issuance of any license. Accordingly, in step 203, for example, the applicant may be fingerprinted (e.g., ten finger prints plus four latent prints). For example, minimal fingerprint capture hardware required by governmental regulatory activity data sources include a scanner having a resolution of 500 dpi, or greater, and capable of transmitting fingerprint information (e.g., to a printer or via an internet connection) to the appropriate governmental regulatory activity data source (step 204) where the information may then be electronically submitted to the FBI, by well known means, for a background check (step 205). Upon completing a background check, save any discovered criminal or otherwise unlawful history, in step 206, the aforementioned governmental regulatory activity data source issues the applicant a license card/certificate including any identity information (e.g., name, address, state, license number, registration number, expiration date, affiliation, barcode, etc.) required to uniquely identify the applicant and/or what the applicant has had licensed and/or certified. This identity information may then be reported to the commodity activity database, wherein the license and/or certificate represents a reporting form.

In another aspect of the present embodiment, and still prior to any issuance of a license and/or certificate, verification may be made as to an applicant's passing of a mandatory/voluntary license test (e.g., retailer, applicator, manufacturer, etc.) related to a particular chemical or its related, practice or process. If it is verified that the applicant has passed any require license test, then a license and/or certificate is generated as described above.

In the one aspect of the present invention, the license card may include a smart-card type device capable of being scanned at a point-of-transaction device (e.g., a UPC bar code scanner, credit card scanner, biometric fingerprint device). In one aspect of the present invention, the license and/or certificate may include a barcode, magnetic strip, and/or a photo ID.

In another aspect of the present embodiment, the applicant may include a registrant (e.g., an individual, company, organization, etc.) applying for the registration of a new commodity chemical or product for review and approval.

Commodity chemical or product information for a commodity chemical, product, and/or its active/inert ingredients being submitted for approval and registration may be entered into a new commodity chemical or commodity product application provided by the reporting logic. Commodity chemical or product information may manually be entered into the application by an approved registrant, or may be submitted to the security database by a registrant in an on-line new commodity chemical or product application form via one of the aforementioned network connections.

Accordingly, in completing the application, the registrant keys into the application a unique commodity chemical or product identification (e.g., EPA ID, etc.) for the commodity chemical or product registration to be requested.

Subsequently, the reporting logic checks to determine whether the unique commodity chemical or product identification has been already entered into the security database. If the unique commodity chemical or product identification has been previously reported, then the security database is checked to determine whether there are multiple commodity chemicals or products and/or inert/active ingredients having the same unique commodity chemical or product identification. If multiple commodity chemicals or products having the same unique commodity chemical or product identification are found in the security database, then a list of all commodity chemicals, products and/or their inert/active ingredients matching the unique commodity chemical or product identification is presented to the agent. The applicant then reads the list and determines whether the new commodity chemical being submitted for accumulation is found in the list.

If either no unique commodity chemical or product identification has been previously submitted to the security database or if the applicant does not find the new commodity chemical or product being submitted for registration and/or approval, then the applicant is prompted by the reporting logic to supply all applicable identity, location, and commodity chemical or product information into the application form (e.g., commodity chemical or product name, type, inert/active ingredients, state-specific values depending upon which states the product will be registered in, a list of states or other governmental agencies in which application for registration is being requested, etc.).

Subsequent to either selection from the list of the new commodity chemical or product being submitted or supplying of the applicable information, the reporting logic assembles other relevant commodity activity elements from the security database into the predetermined fields of the application. Such commodity activity elements include identity information related to the registrant, commodity chemical or product type, etc.

In order to supplement the application for approval and registration of the new commodity chemical or product, the registrant may optionally (unless required by the agencies reported to) provide electronic documents (e.g., labels, MSDS, etc.) that are descriptive of the proposed new commodity chemical or product and that may provide information to facilitate the review and approval process by a registrar.

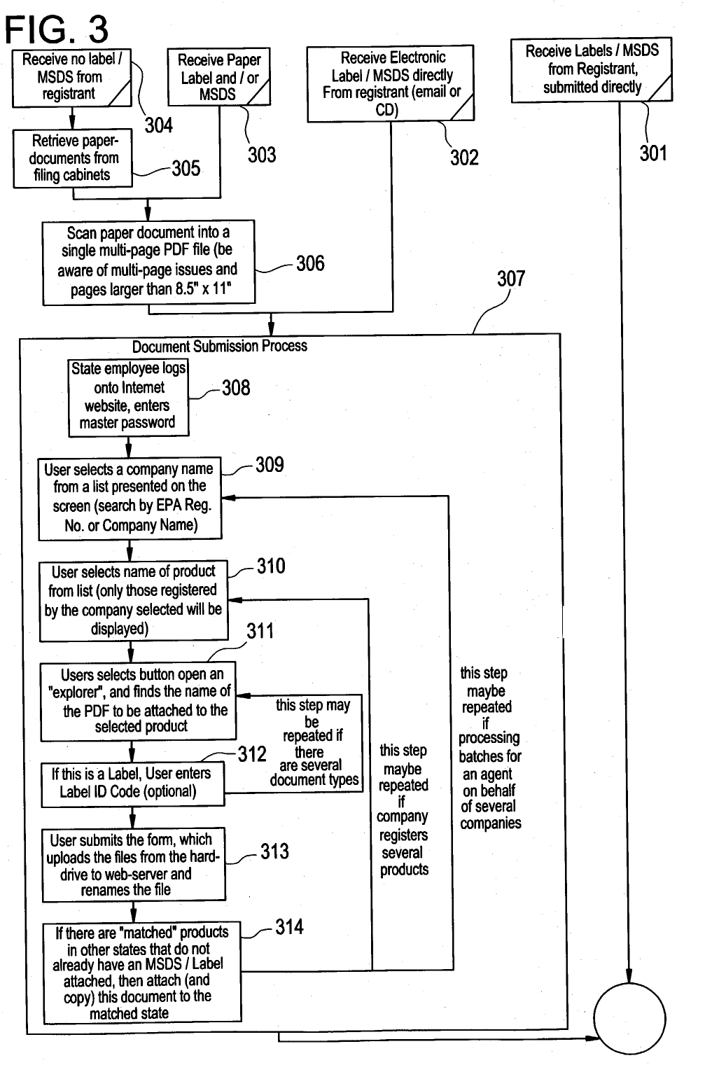

Referring to FIG. 3, in order to supplement the information keyed into the application, the electronic images of the documents may be submitted to the security database directly by the registrant. Accordingly the electronic images of the documents may be provided as a ‘.pdf’ file (or other suitable image format) attached to the application form indicating the latest version or revision date (see step 301). Alternately the documents may be received electronically from the applicant (e.g., via e-mail or CD-ROM) as in step 302, received as paper versions as in step 303, or not received at all, as in step 304. If no documents are provided by the registrant, in step 305, paper documents closely matching the specifications of the new commodity chemical may be produced as a paper version supplied by a party other than the registrant. After their receipt, either of the paper based documents may be scanned into a single or multi-page electronic image of the document as in step 306.

Subsequently, a user (e.g., a registrar or the registrant) enters into a document submission process (see step 307). In order to initiate the document submission process, the user logs onto the security database, via the aforementioned connections, and enters a password to obtain a predetermined level of access to the database (see step 308). In step 309, if the user is, for example, the registrar, a company search by EPA ID or company name may be performed so that the company (or other entity) the registrant is representing may be selected from a list presented to the registrar. On the other hand, if the user is the registrant, the state(s) may be selected from a list of states in which registrations already exist so that the registrant may select the company name from a list of possible company names he/she is responsible for. In step 310, subsequent to company selection, the user selects the name of the product or chemical from a list (only those chemicals or products registered by the company selected will be displayed). In step 311, the user then finds, selects, and opens, by well known means, the name of the electronic image to be attached to the selected commodity chemical that is the subject of the application. If, for example, the electronic image file is a label, in step 312, the user may optionally provide the file with a unique label ID (this step may be repeated as required for multiple electronic image files). In step 313, the user then submits the electronic image file to the security database. The submission process automatically renames the file and generates an internal logical folder structure into which the electronic document is inserted. The renamed electronic image file may, for example, contain EPA ID, product name, revision date, and label ID of the new commodity chemical being submitted for review and approval. In step 314, a matching process may subsequently be performed by the matching logic supported by the security database, as will be described in greater detail below. It should, however, be noted that the matching process may be repeated as required either if the company registers (or has registered) several products or if the reporting logic is processing batches of information for a reporting agent on behalf of several companies.

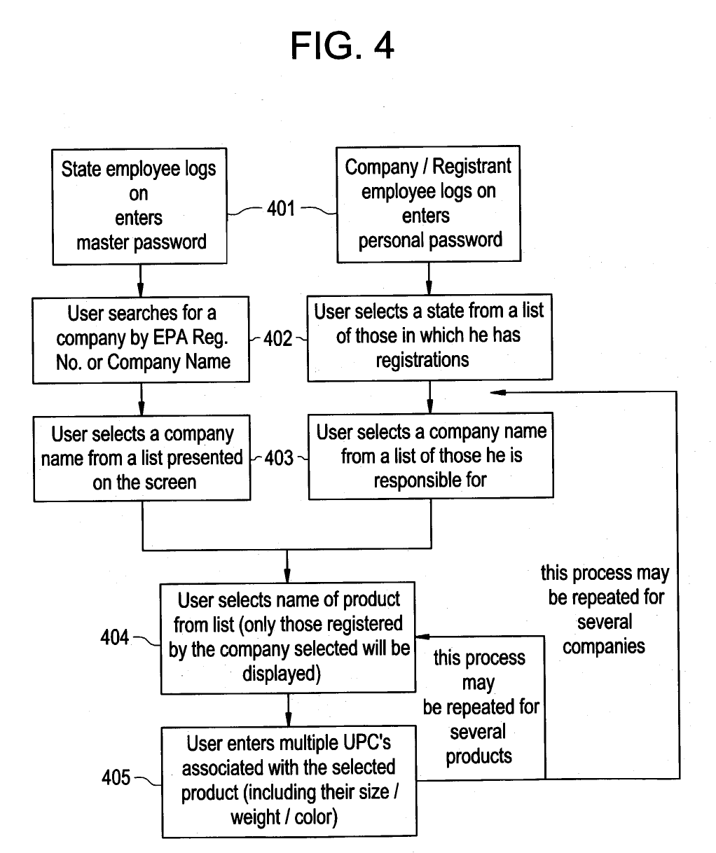

Referring to FIG. 4, in a manner similar as illustrated in FIG. 3, a user (e.g., a registrar or the applicant) may also enter into a UPC submission process. In order to initiate the UPC submission process, the user logs onto the security database, via the aforementioned connections and enters an appropriate password to obtain a predetermined level of access to the database (see step 401). If the user is the registrar, a company search by EPA ID or company name is performed so that the company the applicant is representing may be selected from a list presented to the user/applicant (see step 402). Alternately, if the user is the applicant, the state is selected from a list of those in which he/she has registrations already so that the user/applicant may select the company name from a list of those he/she is responsible for. Subsequent to company selection, in step 403, the user selects the name of the product or chemical from a list (only those chemicals or products registered by the company selected will be displayed) (see step 404). In step 405, the user then enters one or more UPCs associated with the selected chemical or product (including its other commodity chemical or product information such as size, weight, color, etc.). The submission of UPCs may be repeated for several products and/or several companies.

After either the application has been completed by the registrant or an electronic image file of a document has been submitted, the reporting logic automatically adds a new record to the security database for each state where the new commodity chemical is being submitted for review and/or approval or for each state not having a document associated therewith. At the same time, an “approval status” field within the security database may be marked with a “pending” status.

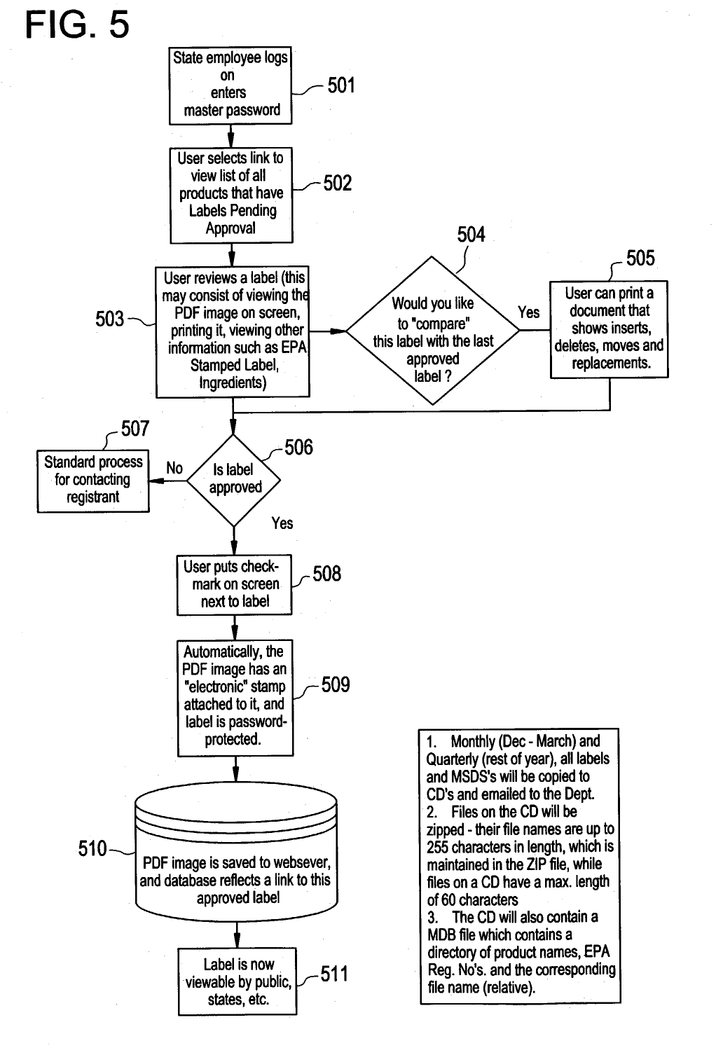

Referring to FIG. 5, after the completing the application, document/UPC submission processes, and/or after receiving the electronic images directly from the registrant, the application may then be held and reviewed by appropriate registrar representing a regulatory/compliance agency in a review/approval process. Accordingly, in step 501, the registrar logs onto the security database via the abovementioned network connections, enters a password and selects a link to a viewlist of all products that have applications/documents pending approval (see step 502). In step 503, the registrar may then review the various applications/documents.

In one aspect of the present invention, the document being submitted may be compared with the last approved document for the commodity chemical under review (see step 504). Accordingly, a registrar may view the new document and an old document, that may show marked-up document insertions, deletions, movements, and replacements, either side-by-side or on a display provided by the security database (see step 505). After either the marked-up documents or the applications have been viewed by the registrar, the registrar determines whether the document/application is approved (see step 506).

If the application/document is rejected, then the reporting logic may send out a rejection notice to the registrant (see step 507).

If, however, the application/document is approved, then the registrar updates the “approval status” field from “pending” to “approved” in the record on the security database (see step 508). In one aspect of the present invention, an electronic stamp may be associated with the document and the document is subsequently password protected such that only a predetermined entity, e.g., the registrar or the applicant, may alter the document (see step 509). In step 510, an image may be saved in the security database and a link may be provided to reflect the approved application, document, UPC, etc. At this point in the process the electronic document becomes available for the general public to view and print via search/selection criteria on the website, by accessing information from the central database (see step 511). The approval of this commodity chemical or product may be sent by email or paper to the registrant at this point.

In one aspect of the present invention, when generating the electronic stamp, the registrar assimilates site and use data for a specific document. Subsequently, the registrar un-marks those sites/crops and/or uses that differentiate the label from the EPA Stamped Approved Label (which is available for review via the EPA's website), In one aspect of the present invention, an electronic copy of an In-Commerce label may be stored within the security database.

An approved document, In-Commerce label, and other data may be saved to the security database and a link to this approved document may be provided within an appropriate database field supported by the security database and cross referenced with other commodity activity elements. Accordingly, the document may now be viewable by any analysts and/or other reporting agents.

In one aspect of the present invention, all documents may periodically or sporadically be copied to CDs and/or e-mailed to appropriate regulatory/compliance agencies. Documents on the CD may be compressed (e.g., document names may be up to 255 characters in length and documents on the CD may have a maximum length of 60 characters). Moreover, the CD may also contain a database file containing a directory of commodity chemical names, EPA IDs, etc. and their corresponding document file names.

In another embodiment of the present invention, a regulatory reporting process may be implemented in a license and/or registration application process where registrar and/or licenser may act as a reporting agent by populating a reporting form using information derived from the aforementioned one or more registration and/or license applications.

In another embodiment of the present invention, the regulatory reporting process may be implemented in a license and/or registration renewal application process. Accordingly, an applicant applying for a renewal of a license and/or registration of any of the aforementioned chemicals, products, ingredients, and/or events may act as a reporting agent by populating a reporting form provided as one or more appropriate license and/or registration renewal applications.

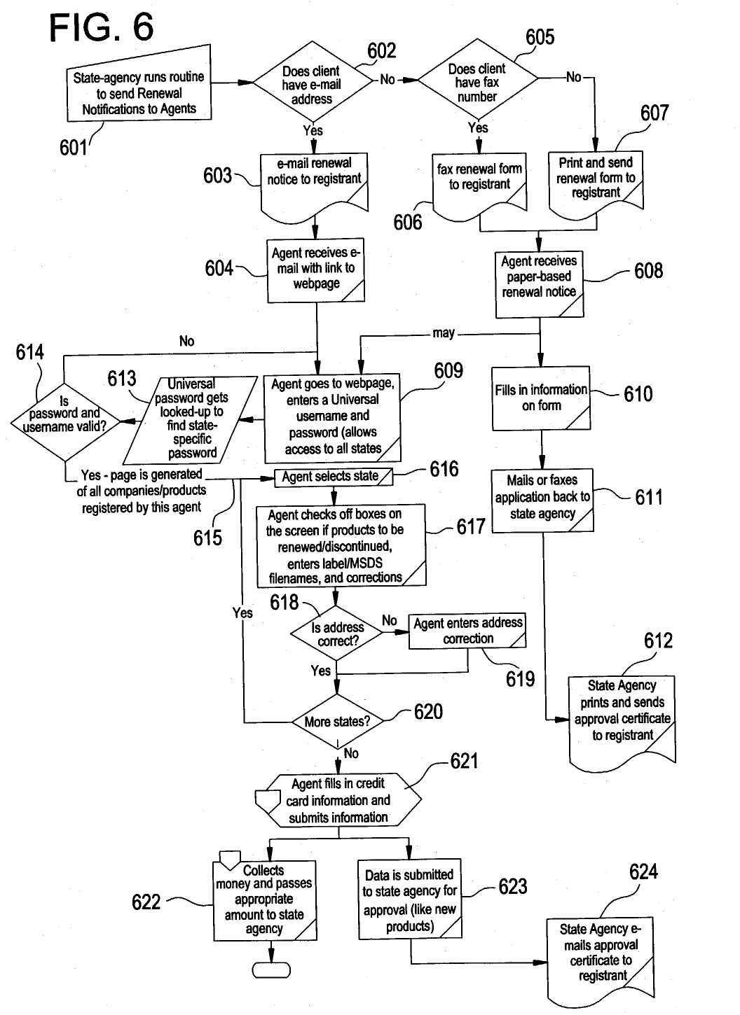

Referring to FIG. 6, the renewal application process automates the generation of forms compliant with various requirements of multiple governmental regulatory agencies. A universal username/password pair may be used to access the security database of username/password pairs for many different commodity activity locations (e.g., states) where a user needs to register a commodity chemical.

The reporting logic executes an algorithm that automatically generates registration/license renewal notices (see step 601) that may be sent (via mail, e-mail, fax, etc.) to holders of the licenses and registrations.

Accordingly, in step 602, it is determined whether the applicant has an e-mail address. If so, then the reporting logic sends a renewal notification e-mail messages to the company or agent (see step 603). In that case, applicant receives the renewal notification e-mail message (see step 604). In one embodiment, the message includes a hypertext link to renewal web site hosted by the security database, whereby the applicant may renew their registrations and/or licenses.

If it is determined that the applicant does not have an e-mail address, then in step 605, it is determined whether the applicant has a facsimile number. If so, then the reporting logic sends a renewal notification and renewal form by facsimile transmission to the applicant (see step 606). In one embodiment, the renewal notification includes an internet address for a renewal web site hosted by the security database, whereby the applicant may renew their registrations and/or licenses.

If it is determined that the applicant does not have a facsimile number, then, in step 607, the reporting logic automatically prints a renewal form and mails a renewal notification and the renewal form to the applicant. In one embodiment of the present invention, the renewal notification includes an internet address for a renewal web site hosted by the commodity activity database, whereby the applicant may sign up to renew their registrations and/or licenses.

Whether or not the applicant has a facsimile number, in step 608, the applicant receives the paper based renewal notice by facsimile or regular mail. The applicant may then decide to access the renewal web site. If so, in step 609, the applicant connects a reporting device to the security database and loads a renewal web page containing a license and/or registration renewal application.

If the applicant decides to perform a paper based renewal, then the applicant manually fills in a renewal form (see step 610). In step 611, the applicant sends the completed renewal form back to the state agency, either by mail or by facsimile transmission. Finally, in step 612, the state agency prints and mails a commodity chemical approval certificate to the applicant. If the renewal includes email or fax addresses, then the certificates may be e-mailed or faxed.

If the applicant decides to perform web-based renewal (see step 609), then the applicant establishes a network connection between a reporting device and the security database hosting the renewal web site. The reporting logic then transmits a renewal log-in form to the reporting device. At this time, the applicant enters a universal username and password that may be used to access a data record in the security database (see step 613). The renewal log in form may then be transmitted back from the reporting device to the security database.

Advantageously, the universal username and password allow the security database hosting the web site to authenticate the applicant for performing on-line renewals of registrations and/or licenses for any of the aforementioned chemicals, products, ingredients, and/or events in any commodity activity location.

In step 614, the security database may be searched to find a data record having the universal username and password. If the universal username and password are not found in the database, then the applicant must request a new universal username and password, and specify the names of companies that the applicant is responsible for.

If the universal username and password are found in the database, then an appropriate application web form listing, for example, all commodity chemicals or products registered or events licensed or registered to be performed by the applicant, is generated and transmitted to the reporting device. Accordingly, in step 615, an application web form may first be generated and transmitted to the reporting device, and the applicant may then select a company from the list, and then the application web form for the selected company is generated and transmitted to the reporting device. Accordingly, an application web form may be generated and transmitted to the reporting device, and the applicant may then select a state from the list, and then the list of companies with registrations in that state is generated and transmitted to the reporting device.

Next, in step 616, the applicant selects and indicates one or more commodity activity locations (e.g., states) it wants to renew and/or discontinue chemical registrations, licenses, or performance in other events. Next, in step 617, the applicant checks off boxes of chemicals, products, ingredients, events, to be renewed, discontinued, or canceled, enters document file names, and corrections for the commodity activity location (e.g., participating state).

Then, a renewal form is transmitted from the security database hosting the renewal web site to the applicant for supplying a change of address or changes of information (see step 618). If the address of the applicant is not correct, then in step 619 the applicant may enter an address correction and submit this information back to the security database.

Next, in step 620, the applicant indicates whether there are additional commodity activity locations (e.g., states), for which it desires to renew, discontinue, or cancel commodity chemical or product registrations/licenses.

If there are no additional states, then the applicant supplies credit card or Automated Clearinghouse (ACH) information against which the charges for the registration renewals may be billed (see step 621). In one embodiment of the present invention, the credit card may be entered into predetermined fields of the renewal form supplied by the security database for the applicant.

Accordingly, the reporting logic automatically bills a registration/license renewal fee or fees against the applicant's credit card (see step 622). In one embodiment, the applicant receives e-mail confirmation of the renewal requests and the credit card charges. Licensing and registration renewal data may be submitted to the selected participating commodity activity locations according to the commodity chemical registrations being renewed in the commodity activity locations (see step 623). In one aspect of the present invention, the security database may be accessed to retrieve the username and/or passwords for the applicant for each participating state in which a registration or a license for a chemical, product, or event is being renewed, discontinued, canceled, etc. Using this username and password, the reporting logic may automate a process of logging in to the selected participating states' renewal system and submitting on behalf of the applicant the renewal application and at least a subset of the renewal data supplied by the applicant. For each selected state, a registrar reviews and approves the renewal application (step 624).

In one aspect of the present invention, the renewal data is submitted in a standardized format accepted by the state, for example in a standard spreadsheet or standard database. The review and approval process may be performed according to the processes described above.

According to principles of the present invention, commodity activity element related to the inspection (in registered dealers known by various Department of Agriculture (DOA) or non-regulated retail establishments), of commodity products, commodity chemicals, their inert/active ingredients their effects, and the like, within a commodity activity location, by any of the aforementioned governmental regulatory and/or third party activity data sources may be reported to the security database in inspection reporting processes. Thus, reporting forms used in inspection reporting processes may include predetermined fields that contain commodity, activity element sets related to identity information, commodity product information, commodity chemical information, transaction information, location information, health information, and inspection information.

In one aspect of the present invention, an inspection reporting process may be implemented in an inspection process involving the documentation and/or analysis of commodity products, commodity chemicals, their inert/active ingredients and/or their packages. Accordingly, an inspector performing the inspection may act as a reporting agent by populating a reporting form provided as one or more inspection reporting forms.

Accordingly, an inspector representing a governmental regulatory and/or third party activity data source may inspect records related to transaction, production, and usage, etc., of commodity products, commodity chemicals, and/or their inert/active ingredients from any of the aforementioned working activity data sources, analyze samples of commodity products, commodity chemicals, and/or their inert/active ingredients within any of the aforementioned commodity activity locations to verify consistency with any local, state, federal, or internationally imposed labeling requirements, validate registrations and licenses of commodity chemicals and/or their inert/active ingredients, inspect handling establishments using commodity chemicals, processors/packers using commodity chemicals, determine concentrations, amounts, locations, and effects of commodity chemicals and/or their ingredients, and inspect and monitor commodity chemicals and/or their inert/active ingredients, or various commodity products associated with the commodity chemicals that are imported and/or exported into or out of the United States of America (USA), Canada and Mexico.

Further, commodity chemical information specific to a particular commodity activity location (e.g., information related to state restricted use products (S-RUPs), state limited use products (SLUPs), state local need products (SLNs), toxic commodity chemical combinations (binary chemicals), etc.) may also be reported to the security database by inspectors.

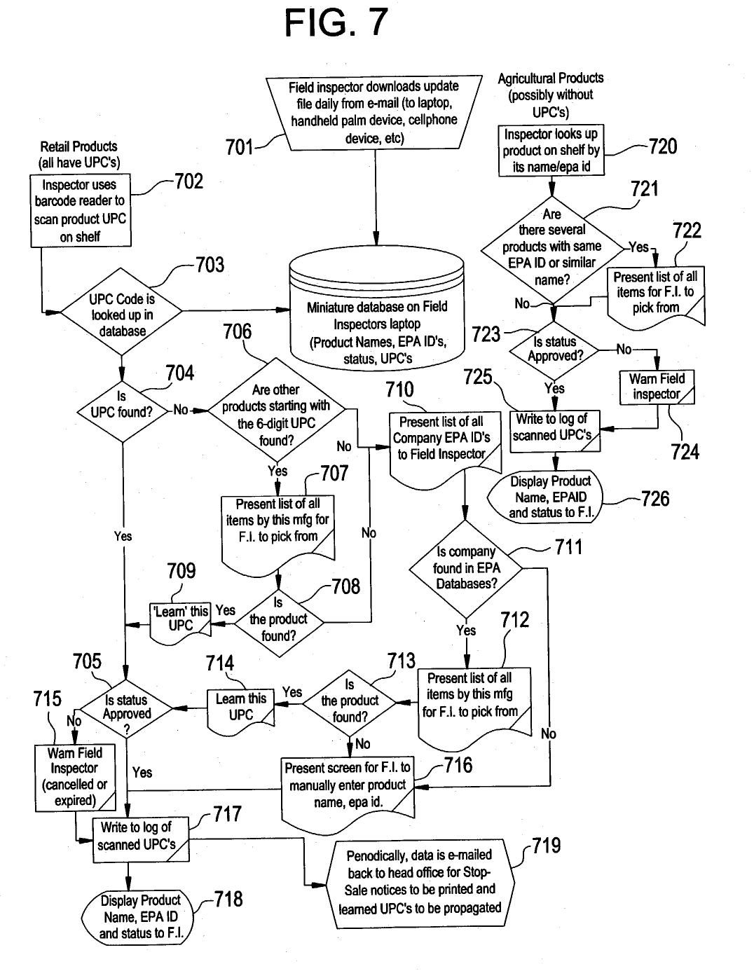

Referring to FIG. 7, in one embodiment of the present invention, an inspector may act as a reporting agent for a governmental regulatory activity data source and a reporting device (laptop, PDA, ruggedized electronic device) used by the inspector may support an inspection database 1. The inspection database may, for example, be organized in a manner similar to that of the security database. However, the inspection database may contain only a limited number of the predetermined fields corresponding to the aforementioned attributes involved in the particular reporting process (e.g., fields containing records defined by names of commodity products, commodity chemicals and/or their ingredients, EPA IDs, registration status of commodity chemicals/products (e.g., pending, approved, cancelled, etc.), UPC codes, quantity of units, unit type, etc.). Further, the inspection database includes commodity activity elements of identity, commodity product, commodity chemical, and transaction information that are specific to the commodity activity location within which an inspector is performing the inspection.

Accordingly, inspectors may, for example, update the security database by scanning universal product code (UPC) bar codes on packages of commodity products, commodity chemicals and/or their inert/active ingredients found within working activity data sources during inspections. The process includes safeguards to prevent erroneous data entries and includes a self-learning update process, as will be described in greater detail below.

Accordingly, in one aspect of the inspection reporting process, UPCs for commodity chemicals may be “learned” and the security database may be automatically updated to include new commodity activity elements during inspection.

For example, in step 701, an inspector may download the inspection database from the security database to the reporting device on a daily basis. Accordingly, an inspector may download identity, commodity product, commodity chemical (including commodity activity elements containing UPC data), and transaction information. In one aspect of the present invention, the inspection database may be downloaded using e-mail, direct network connection, wireless network connection, and the like. In another aspect of the present invention, the downloading may be performed by the inspector periodically or sporadically. Further, the inspector may download a completely new (e.g., updated) inspection database, or a supplement of additional records from the security database. Also, any information captured on the device may simultaneously be uploaded to the security database.

According to one aspect of the present invention, the reporting device may include a supplemental device such as an optical bar code reader capable of scanning a UPC bar code of a commodity chemical and/or the business license within a commodity activity location of a working activity data source (e.g., on a store shelf of a retailer or wholesaler, on a loading dock of a producer, etc.).

In step 702, upon scanning the bar code UPC, commodity product or commodity chemical may be looked up within the inspection database (see step 703). At step 704, it is determined whether the UPC is found in the inspection database. If the UPC is found, then in step 705 the corresponding commodity chemical/product status is determined to discover if is approved for transaction.

If, however, the UPC is not found in the inspection database, it may be possible that the commodity chemical/product already exists in the inspection database, but the inspection database does not include a UPC record in the UPC field. Therefore, in step 706, the first six digits of the UPC, i.e., digits corresponding to a producer (e.g., manufacturer, formulator, etc.) code, are checked to determine whether they match the first six digits of any of the UPCs stored in the inspection database.

If a match for the first six digits exists of a commodity chemical/product exists in the inspection database, then the identity of the working or technician activity data source associated with that commodity chemical/product may be determined. The identity of the working or technician activity data source may be used to locate the corresponding commodity chemicals/products existing in the inspection database. More specifically, the inspection database record or records may be accessed to identify a corresponding producer for the commodity chemical/product. Accordingly, the inspection database may be accessed to determine all commodity chemicals/products and listed for the identified working or technician activity data source.

Then, in step 707, the reporting device presents to the inspector a list of all commodity chemicals/products from the identified producer that are included in the inspection database. The list may be displayed on an LCD display screen or other suitable data output device. In one aspect of the present invention, the list may include the name of the commodity chemical/product, EPA ID, and/or other information suitable for enabling an inspector to correlate the scanned UPC with a stored commodity chemical/product.

Next, in step 708, the inspector reads the list and compares the listed commodity chemical/product information with the commodity chemical/product in the aforementioned commodity activity location whose package has been scanned. If there is a match, then the inspector indicates which particular commodity chemical/product in the list matches with the scanned bar code UPC. This may be done by clicking a mouse button next to the correct commodity chemical/product listing, by highlighting the correct commodity chemical listing and typing “enter”, or by other well known means (see step 709).

After a successful match of a UPC to the scanned commodity chemical/product, the inspection database may then be updated to add the scanned bar code UPC as another valid UPC record for the scanned commodity chemical/product. The approval status of the corresponding commodity chemical/product is then determined (see step 705).

If no match for either the aforementioned first six digits or the listed commodity chemical information exists, then the reporting device presents to the inspector a list including identification information related to any of the aforementioned working or technician activity data sources (see step 710). This list is built from searching through fields containing identification information of each data record in the inspection database. The list may be displayed on an LCD display screen or other suitable data output device. In one aspect of the invention, for each commodity chemical/product being scanned, the generated list may include identification information containing commodity activity elements suitable for enabling an inspector to correlate the identification information on the scanned commodity chemical/product with a stored identification information.

Next, in step 711, the inspector reads the list containing the identification information of the working or technician activity data sources and compares the listed information with any identification information printed on the package of the scanned commodity chemical/product that the inspector is checking.

If a match of the identification information exists within the inspection database, then the inspector indicates which particular commodity activity element within the listed identification information matches the scanned commodity chemical/product. This may be done by clicking a mouse button next to the correct commodity chemical/product listing, by highlighting the correct commodity chemical/product listing and typing “enter”, or by other well known means.

Next, in step 712, the reporting device presents to the inspector a list of commodity chemicals/products from the working or technician activity data sources having the selected identification information. This list is built from searching through all data records in the inspection database to identify all data records having the selected identification information. The list may be displayed on an LCD display screen or other suitable data output device. In one aspect of the present invention, the list may include the name of the commodity chemical/product, EPA ID, and/or other information suitable for enabling an inspector to correlate the scanned UPC with a stored commodity chemical/product.

Next, in step 713, the inspector reads the list and compares the listed commodity chemicals with the commodity chemical/product in the aforementioned commodity activity location whose package has been scanned.

If a match for the first six digits of a scanned commodity chemical/product exists in the inspection database, then the inspector indicates which particular commodity chemical/product in the list matches the scanned UPC. This may be done by clicking a mouse button next to the correct commodity chemical/product listing, by highlighting the correct commodity chemical/product listing and typing “enter”, or by other well known means.

After a successful match of a UPC to the scanned commodity chemical/product, the inspection database may then be updated to add the scanned bar code UPC into the UPC field for the scanned commodity chemical/product (see step 714). The approval status of the corresponding commodity chemical/product is then determined (see step 705).

In order to determine the approval status of a commodity chemical/product that is updated within the inspection database, it is determined whether a flag has been entered into an “approval status” field for the commodity activity element set in the inspection database. If the commodity chemical/product is determined not to have been approved (e.g., canceled, expired, pending, etc.), then a warning may be displayed to the inspector indicating that the product is expired, canceled, pending, etc., (see step 715)

If, however, no match for either the identification information or the aforementioned first six digits exists, then the reporting device presents to the inspector a screen containing an inspection form made available as an electronic reporting form (see step 716). Accordingly, the inspector manually enters identification, commodity chemical/product, transaction, inspection, information for the scanned commodity chemical/product into the inspection database. In one aspect of the present invention, the reporting device presents to the inspector an inspection form on a display screen whereby the inspector may manually enter commodity chemical/product name, UPC, EPA ID, commodity chemical/product package size, and other appropriate commodity activity elements for the scanned chemical/product. Accordingly, the UPC for the scanned commodity chemical/product is automatically added and a flag is also set within an approval status field supported by the inspection database. In one aspect of the invention, the flag indicates that the newly added UPC record, and all corresponding commodity activity elements within a commodity activity element set, is a completely new record in the inspection database. Flagging ensures that a follow-up check may be later performed to determine whether the commodity chemical has been approved for transaction (e.g., sale) within a predetermined commodity activity location, so that a notice (e.g., “stop sale”) may be sent to the working or technician activity data source at a later time if the commodity chemical/product is determined to be unapproved (see step 719).

After either the inspection form has been populated with commodity activity elements or the commodity chemical/product has been determined to be approved or not approved for transaction, the scanned commodity chemical/product is written to a log of scanned commodity chemicals supported by the inspection database (see step 717).

Subsequently, in step 718, the reporting device displays the name of the commodity chemical/product, EPA ID, and approval status to the inspector and the inspector may check another commodity chemical/product to inspect. Accordingly, the process may be repeated as many times as necessary.

In another embodiment of the present invention, commodity chemicals/products may not be packaged with a UPC printed thereon. Accordingly, the inspector may search commodity activity elements in the inspection database for any matches to the name of the commodity chemical/product or EPA ID of the commodity chemical/product being inspected (see step 720).

In one aspect of the present invention, the reporting device determines whether multiple data records for commodity chemicals/products matching the commodity chemical/product information submitted for search by the inspector exist on the inspection database (see step 721). If such data records exist, a UPC is applied to the inspected commodity chemical/product as similarly described above.

Alternatively, if no data records exist in the inspection database, in step 722, the reporting device presents to the inspector a list of commodity chemicals/products matching the commodity chemical/product information provided on the package of the commodity chemical/product. The inspector then selects the correct commodity chemical/product from the list and a UPC is applied to the inspected commodity chemical/product as similarly described above.

Subsequently, the reporting device checks the approval status field in the inspection database for the inspected commodity chemical/product to determine whether it is currently “approved” (see step 723). As described above, the commodity chemical/product has not been approved, a warning is displayed to the inspector indicating that the commodity chemical/product is expired, canceled, or pending (see step 724).

Next, the UPC of the scanned product is written to a log of scanned commodity chemicals/products (see step 725).

Subsequently, the reporting device displays the name of the commodity chemical/product, EPA ID, and approval status to the inspector and the inspector may check another commodity chemical/product to inspect. Accordingly, the process may be repeated as many times as necessary (see step 726).

Periodically or sporadically, after the inspector has scanned commodity chemicals/products for one or more commodity activity locations, the inspector may communicate the log of inspected commodity chemicals to the security database. Accordingly, the UPCs for the various commodity chemicals inspected may be “learned” and the security database may be updated.

Both the log and the new UPC information may be communicated to the security database via the Internet, e-mail, or by connecting to a server of the security database through a standard wired or wireless network connection.

The process includes safeguards to prevent erroneous data entries to the security database. In one aspect of the present invention, when a new UPC is communicated to the security database, a flag is set to identify a new UPC. The new UPC is not confirmed until it is communicated again a second time during a subsequent update of the database.

In yet another embodiment of the present invention, an inspector may act as a reporting agent for a third-party activity data source and the reporting device used by the inspector may support an analysis database, GPS device, chemical analyzing equipment, and/or a digital camera. The analysis database may contain inspection information including commodity activity elements specific to third-party activity data sources. Further, the analysis database may include commodity activity elements including identity, commodity product, commodity chemical, and location information. Accordingly, inspectors may update the security database by analyzing, either in the field or in a laboratory setting, soil, water, air, or organism (e.g., plants, bacteria, animals, etc.) samples taken from commodity activity locations. The analysis would then provide commodity activity elements related to locations, amounts, concentrations and effects of commodity products, commodity chemicals, and/or their inert/active ingredients within commodity activity location. After analysis is complete, the inspector may report the inspector information via electronic or paper based inspection forms.

Accordingly, the aforementioned inspection forms may be made available as reporting forms to the aforementioned inspector through reporting logic provided by the security database. Accordingly, the inspector may supply identity, commodity chemical, inspection, and location information to the extent that the supplied information uniquely defines the inspection. In one aspect of the present embodiment, an inspection may be uniquely defined when the inspection time/date, commodity activity location, and commodity chemical analyzed, are reported such that no two inspection reports are alike. In yet another embodiment of the present invention, an inspection reporting process may be implemented by technicians (e.g., veterinarian, veterinary technician, or other entity having medical diagnostic capabilities) acting as a reporting agent for a technician activity data source. Accordingly, the reporting device used by the technicians may support the analysis database. The analysis database may contain information including commodity activity elements specific to technician activity data sources. Further, the analysis database may include commodity activity elements including identity, commodity product, commodity chemical, health information, and location information. Accordingly, technicians may update the security database by analyzing, either in the field or in a laboratory setting commodity products in various commodity activity locations. The analysis would provide commodity activity elements related to locations, disease types, specific diseases, amounts, symptoms, and other relevant commodity chemical, commodity product, and health information. After analysis is complete, the technician may report the inspector information via electronic or paper based inspection forms.

According to another aspect of the present invention, the reporting devices used by the inspectors or technicians may additionally include a GPS device such that every time a record is updated on the database supported by the reporting device (e.g., a PDA), the GPS device generates location information (e.g., latitude/longitude, altitude, precision) that corresponds to the particular inspection.

Additionally, the reporting device of the present aspect of the invention may include a chemical analyzer and/or a digital camera. Accordingly, the chemical analyzer may be coupled to the PDA and GPS device such that every time a commodity chemical and/or its active ingredients are identified, a new record is created on the database supported by the PDA and the GPS device generates location information (e.g., latitude/longitude) that corresponds to the particular inspection.

Further, reporting devices including a GPS device and a digital camera may be used to track and identify livestock. For example, a digital camera coupled to a reporting device may be used to capture an image of a brand placed on livestock (e.g., cattle). The security database may contain image files of a plurality of different brands for different livestock. Associated with each of the image files is identity information related to the individual or organization responsible for that particular livestock brand, or related to the image (e.g., contains left-arrow, looks like letter K, etc.). Image recognition software supported by the PDA analyzes the image captured by the digital camera and compares that captured image with the plurality of images stored on the security database. The GPS device may then be used to determine the activity location of the livestock group. Accordingly, an inspector may provide commodity activity elements related to the position, number, type, and responsible parties for a commodity product (e.g., livestock) to the security database. Further, in a similar manner as described above with respect to UPCs and EPA IDs, an inspector may use the captured image of the brand to determine the registration status of the particular brand.

Accordingly, the PDA/GPS based reporting device may be used to simultaneously track and record a plurality of commodity chemicals and products, in addition to the position and migration of beneficial and deleterious organisms (e.g., boll-weevils, glassywing sharpshooters, etc.) within an activity location for the purpose of developing eradication programs. The results of these locations, and quantities of commodity chemicals, products or other organisms may be plotted on a regional (county, state, etc.) map showing concentrations and movement/migration patterns.

In yet another embodiment of the present invention, a commodity security reporting center may conduct sampling surveys of producers, technicians, etc., to determine how sales commodity chemicals/products correspond to commodity chemical/product consumption. For example, a commodity security reporting center may perform a statistically valid sampling of producers, technicians, etc., to correlate the date(s) and amount(s) of their commodity chemical purchases. Thus, the combination of transaction information and sampling surveys may be used to generate commodity chemical/product usage data.

Accordingly, a surveyor working for a survey center (state agency or federal security authorities) may act as a reporting agent and report transaction information obtained through working activity data sources and produce individual and/or cumulative commodity chemical data transaction reports. Each individual commodity chemical transaction report may include transaction date, zip code, county, name of commodity chemical, EPA ID, inert/active ingredients, commodity chemical type, commodity chemical quantity, and inert/active ingredients quantity. The commodity chemical reporting center may also produce aggregate commodity chemical transaction reports (e.g., the total number of pounds of commodity chemical “X” that was used in county “Y” between specified dates, the number of liters of inert/active ingredients “A” that were sold in zip code “B” in a given year, etc.). Accordingly, the commodity chemical reporting center may determine and report (or represent geographically) the quantity of any commodity chemical and/or its inert/active ingredients involved in a transaction in any commodity activity location over any desired time period, in addition to layering other locational information which may pertain to nearness of mutually hazardous products or conditions.

According to the principles of the present invention, commodity activity elements related to sale, transfer, distribution, and import/export events (i.e., transactional events) of commodity products, commodity chemicals, and/or their inert/active ingredients by any of the aforementioned working or governmental regulatory activity data sources may be reported to the security database in transaction reporting processes. Thus, reporting forms used in transaction reporting processes may include predetermined fields that contain commodity activity element sets related to identity information, commodity product information, commodity chemical information, location information, and transaction information.

Herein, the term “transaction” may be used to represent the transfer of possession, control, jurisdiction, etc., of a commodity product, a commodity chemical, and/or its inert/active ingredients between members of a transaction party (e.g., a providing party and a receiving party). In one aspect of the present invention, a providing party may include, for example, an exporting agent for a country, producer, manufacturer, wholesaler, retailer, etc., and a receiving party may include for example, an importing agent for a country, wholesaler, formulator, retailer, farmer, consumer, etc., respectively. Accordingly, a transaction may, for example, include the sale of a commodity chemical from a retailer to a producer, technician, etc.; the transfer of an agricultural commodity product or commodity chemical and/or its inert/active ingredients between different locations within a single producer (e.g., transfer of an inert/active ingredients between a party manufacturing an inert/active ingredients and a party responsible for transporting the inert/active ingredients from the manufacturing site to a storage site), etc.; the importing of a herd of cattle from Mexico to the United States of America; exporting apples from New York to Canada, etc.

In one aspect of the present invention, a transaction reporting process may be implemented before, during, or after a given transaction transpires. Accordingly, a transaction agent present during, or responsible for recording, a particular transaction may act as a reporting agent (e.g., a border agent, cashier, inventory manager, supply manager, shipping manager, etc.) by populating a reporting form provided as one or more appropriate transaction forms (e.g., invoices, receipts, order forms, inventory lists, etc.)

As similarly described above with respect to the inspector acting as a reporting agent on behalf of the governmental regulatory or third party activity data source, a transaction agent may recognize, with a corresponding reporting device such as a transaction device equipped with an optical bar code scanner, a commodity chemical by unique commodity chemical/product identifying information (e.g., UPC, EPA ID, cattle brand, etc.). Transaction forms may be subsequently populated with commodity activity elements based on recognition of the unique identifying information of the commodity chemical/product.

Accordingly, the transaction agent may provide location information identifying any of the identity of the transaction agent, the providing party, and/or the receiving party, where the commodity chemical/product will be used, stored, disposed of, sold, the distribution route used to transport the commodity chemicals/products, and/or their inert/active ingredients, etc., as required by any local, state, federal, or internationally imposed regulatory and/or compliance requirements.

In one aspect of the present invention, the transaction forms may, at least in part, be populated with commodity activity elements by scanning a license/registration card of a receiving party (e.g., producer, technician, etc.,) prior to the transfer (e.g., sale) of commodity chemical/product(s) from a providing party (e.g., a retailer). In another aspect of the present invention, the transaction form may, in part, be generated by scanning a finger of the transaction party on a biometric device (e.g., fingerprint authentication device). Accordingly, by scanning the license/registration card and/or the finger of the transaction party, at least one of the identity of one member of the transaction party, time of transaction, and location of transaction may be simultaneously inputted into the transaction form. Subsequently, software supported by reporting logic automatically fills in missing fields required to complete the identities of the receiving party and/or the providing part, commodity chemical/product information, and transaction information pertaining to the transaction event. This process may also determine pre-authorization for a transaction event to occur, as well as recording and reporting the transaction event after it has occurred.

Periodically or sporadically, after at least one transaction report has been populated, the transaction agent may communicate the transaction reports to the security database. Alternatively, a magnetic, optical disk, paper form, or other suitable data storage medium may be provided to the security database via a courier service.

In contrast to the embodiment described above, where commodity activity elements originate from a transaction agent filling out reporting forms provided by the security database, commodity activity elements may alternately originate from a transaction agent populating custom transaction forms provided by an appropriate governmental regulatory activity data source and/or the activity data source represented by any one of the transaction parties. Accordingly, upon completion of the custom transaction forms, the governmental regulatory activity data source and/or the activity data source represented by any one of the transaction parties, acting as a reporting agent, may submit either electronically or through courier service, the populated transaction forms for processing by the security database.

In another aspect of the present invention, a transaction reporting process may be implemented when a potential receiving party accesses a web site offering the sale of commodity chemicals and/or commodity products. Accordingly, a “cookie” may be generated and directed to the security database. Information contained within the cookie may include identity and location information about the potential receiving party (e.g., the web surfer) and the contents of the web page (e.g., types and names of commodity chemicals/products) advertised on the web page.

According to the principles of the present invention, commodity activity elements related to the consumption (e.g., use) of commodity products, commodity chemicals, and/or their active/inert ingredients by any of the aforementioned working activity data sources may be reported to the security database in consumption reporting processes. Thus, reporting forms used in consumption reporting processes may include predetermined fields that contain commodity activity element sets related to identity information, commodity product information, commodity chemical information, location, and consumption information.

In one aspect of the present invention, a consumption reporting process may be implemented before, during, or after consumption of a commodity product, commodity chemical, and/or its inert/active ingredient transpires. Accordingly, a consumer, e.g., a producer, distributor, a technician, or any person or organization that consumes commodity products, commodity chemicals, and/or their active ingredients, may act as a reporting agent by populating a reporting form provided as one or more consumption forms (e.g., forms related to the consumption of commodity products, commodity chemicals, and/or inert/active ingredients in the manufacture, formulation, generation, or processing of commodity products, commodity chemicals, and/or their active ingredients by producers and/or technicians).

Accordingly, the consumer may supply commodity activity elements related to identity, location, commodity chemical, and/or consumption information as required by relevant regulatory and/or compliance requirements. In one aspect of the present invention, the consumption forms may, at least in part, be populated with information using a reporting device. Using the reporting device, a producer, distributor, or technician may, for example, log onto the security database via any of the aforementioned network connections with the reporting device, enter the identity of the consumer (e.g., provide a name, applicator ID, etc.), and enter activity location information (e.g., a state code representing the state in which the consumption transpires, has or will transpire). Reporting logic supported by the security database accepts the consumer identity and state code as an input and returns a true or false value validating that the consumer ID represents a valid consumer in whatever state designated by the state code. The consumer then enters descriptive consumption information about the commodity chemical/product involved in consumption (e.g., EPA ID, name of commodity chemical, UPC, etc.). An exact or partial lookup capability, as previously described with respect to the regulatory and/or inspection reporting processes, may be provided by the reporting logic in order to match the EPA ID, name, UPC of the commodity chemical/product involved in the consumption to an equivalent product or chemical in the security database. The reporting logic supported by the security database then accepts the aforementioned information and state code as inputs registered in the state designated by the state code. The consumer then selects the name of the commodity chemical, product, or ingredient that is being/going to be used in an event (e.g., applied) from a list of commodity chemicals, products, or ingredients registered in the designated commodity activity location (e.g., state). The consumer then enters other consumption information, as it is available, into the computing device. Entry of descriptive consumption information may be repeated if multiple commodity chemicals/products involved in production and/or consumption instances are required. After the consumption setup step, the consumer may enter any of the other aforementioned consumption information concerning the amount, rate, purpose, and exact location of commodity chemical/product/ingredients consumed.

In one embodiment of the present invention, a data card may be used as a supplemental device. Accordingly, the data card (e.g., PCMCIA card) may be used to capture all of the data inputted by the applicator in the application setup step. After data capture, the data card may then be removed from the reporting device and inserted into a recording device located on the machine or implement (e.g., tractor, backpack, sprayer, etc.) used to facilitate actual consumption of the commodity chemical/products and/or inert/active ingredient. The recording device may, for example, record the amount, rate, and/or specific location (with the use of GPS or other locating method) of commodity chemical/product/ingredients applied. After consumption, the data card may then be inserted into the reporting device, synchronized, and submitted to the reporting logic on the security database.

According to the principles of the present invention, commodity activity elements related to the production (e.g., manufacture, formulation, generation, processing, etc.) of commodity products, commodity chemicals, and/or their inert/active ingredients by any of the aforementioned production activity data sources may be generated in production reporting processes. Thus, reporting forms used in production reporting processes may include predetermined fields that contain commodity activity element sets related to identity information, commodity chemical information, commodity product information, location information, and production information.

In one aspect of the present invention, a production reporting process may be implemented during or after production of a commodity product, commodity chemical, and/or its inert/active ingredients. Accordingly, a producer may act as a reporting agent by populating a reporting form provided as one or more production forms (e.g., forms related to the production of commodity products, commodity chemicals, and/or their inert/active ingredients).

Accordingly, the producer may supply commodity activity elements related to identity, location, commodity chemical and/or commodity product information as required by relevant regulatory and/or compliance requirements in a similar manner as described above with respect to consumption reporting.

Using the reported commodity activity element sets provided by the aforementioned reporting forms, the security database builds a database of aggregate commodity activity element sets.

For example, the one aggregate commodity activity element set may include commodity activity element sets provided within activity reports originating from a chemical producer (e.g., a manufacturer of a pesticide), a product producer (e.g., a non-organic farmer of wheat using the pesticide), a food processor (e.g., feed mills processing the wheat into feed), a breeder (e.g., a cattle rancher feeding cattle with the feed), and a retailer (e.g., a grocery store selling steak provided by the cattle). In the example above, a pesticide may be tracked from its creation to its immediate application on wheat to its ingestion by cattle to its introduction into a commercial marketplace selling steak. By incorporating commodity activity element sets provided by other activity data sources or other activity reports, the aggregate commodity activity element set mentioned above may be used to show the relevant registrations and licenses held by the manufacturers, farmers, ranchers, retailers, etc., as well as the identity of the governmental regulatory entity that issued the registrations and licenses.

Accordingly, the reporting logic helps to build a security database containing commodity activity elements related to all commodity chemicals commodity products, their active/inert ingredients and/or their related events in every commodity activity location.

The security database may be supported by a single system or spread over many systems connected together via a secure wired or wireless connection. The security database may be a SQL, Oracle, Access, or other type of relational database management system. The server(s) supporting the security database may be hosted by datacenters such as Digex™. Web and database servers supporting the security database according to the present invention may be built with bunker style construction, housed in data centers secured (physically and logically) with the most up-to-date technology, such as keycards and biometric palm readers, surveillance systems with fixed and roving security guards, firewalls and VPN's, monitoring services to prevent and expose viruses, DoS attacks, etc. The data centers of the present invention may offer redundant power generators, air cooling and fire suppression systems. The data centers may also be connected to several fast and reliable Internet backbones. Every aspect of redundancy may be implemented to ensure availability of the security database, and may be mirrored over multiple physical locations for a maximized level of redundancy.

Users of the security database of the present invention (e.g., reporting agents and analysts, as will be discussed in greater detail below) act in varying capacities and, therefore, necessitate multiple levels of access to the security database. Sensitivity to information contained in the security database may be based on the identity (e.g., username, password, biometric identification, etc.) of the user interacting with the security database. Accordingly, users may be represented by varying degrees of authentication based on the sensitivity of the data they are accessing and/or providing. Portions of the security database may only require a standard login and password. Other areas, however, where there is a need to guarantee the authenticity of the user, may employ more sophisticated authentication schemes such as biometric identification using a fingerprint or iris scan or the like. Once a user's security credentials have been verified, access to the security database is allowed in areas only where the access has been authorized.

Stored within the security database is a listing of the user's attributes. These attributes may contain identification information (e.g., name, affiliation with a particular activity data source, address, password, username, etc.), what level of security they have been assigned, and which features and functions of the system they can access.

In one embodiment of the present invention, access to the security database may be provided via a custom built web interface. Whenever sensitive commodity activity elements are accessible via the Internet, it is critical that the system of the present invention ensures that a third party is unable to intercept or tamper with any activity reports. In order to ensure this level of security, transport layer security may be implemented to ensure an encrypted connection between the web server supporting the security database and the user. In order to guarantee the transport layer security, common secure communication protocols such as Transport Layer Security (TLS version 1.0), Secure Sockets Layer (SSL versions 2 and 3), and Private Communications Technology (PCT version 1.0) may be supported. Each of these protocols provides both encryption services (for confidentiality of exchanged data) and authentication services (for mutual identification between clients and servers).

Users having different levels of authentication and authorization may be able to view different subsets of commodity activity data elements within the security database. For example, a state agent may be logged in using a username and password and be able to view concentrations of applied Phostoxin chemicals in relation to rivers and streams in their state, however federal security authorities may be able to be logged in using biometric methods and have access to multiple GIS layers, one of which would show concentrations of applied Phostoxin chemicals in relation to other GIS information (such as known thefts of chemicals, grain warehouse locations), possible other data merged from external sources (such as immigration data).

If, upon submission of the commodity activity element sets within the activity reports, any EPA IDs are incorrectly reported (e.g., if an EPA ID is incorrectly reported as XX-YYA) it will be so recognized, and a user will have to enter a valid value in order to correct the reported EPA ID to the correct target EPA ID prior to insertion of that commodity activity element into the security database. The reporting logic then creates an error file for that particular target EPA ID containing the incorrectly reported EPA ID so that any subsequent incorrectly reported EPA IDs may be corrected toward the target EPA ID.

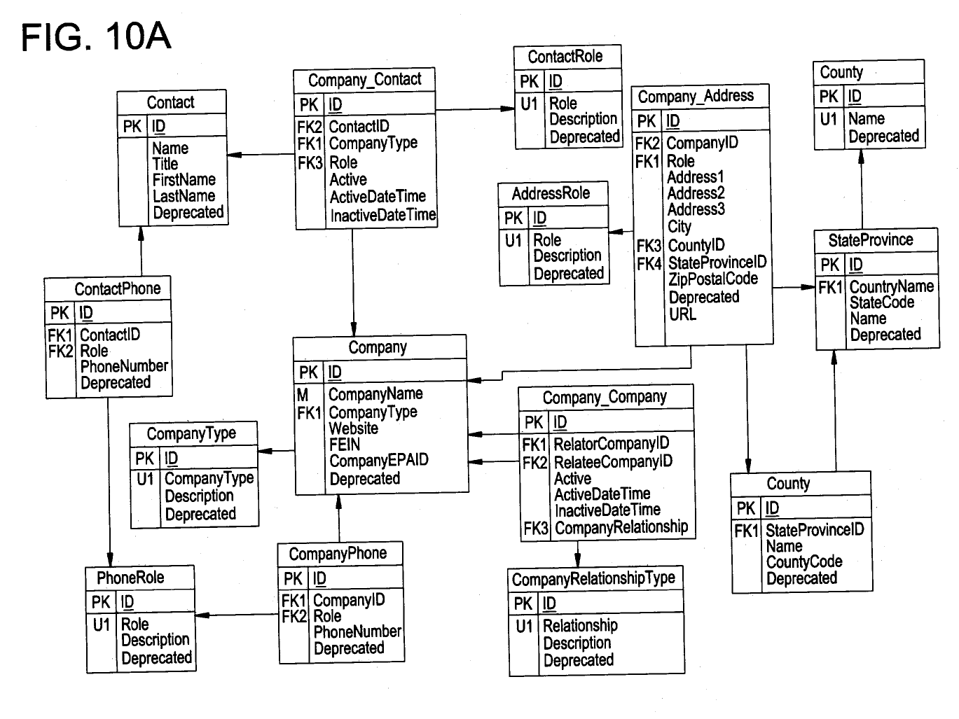

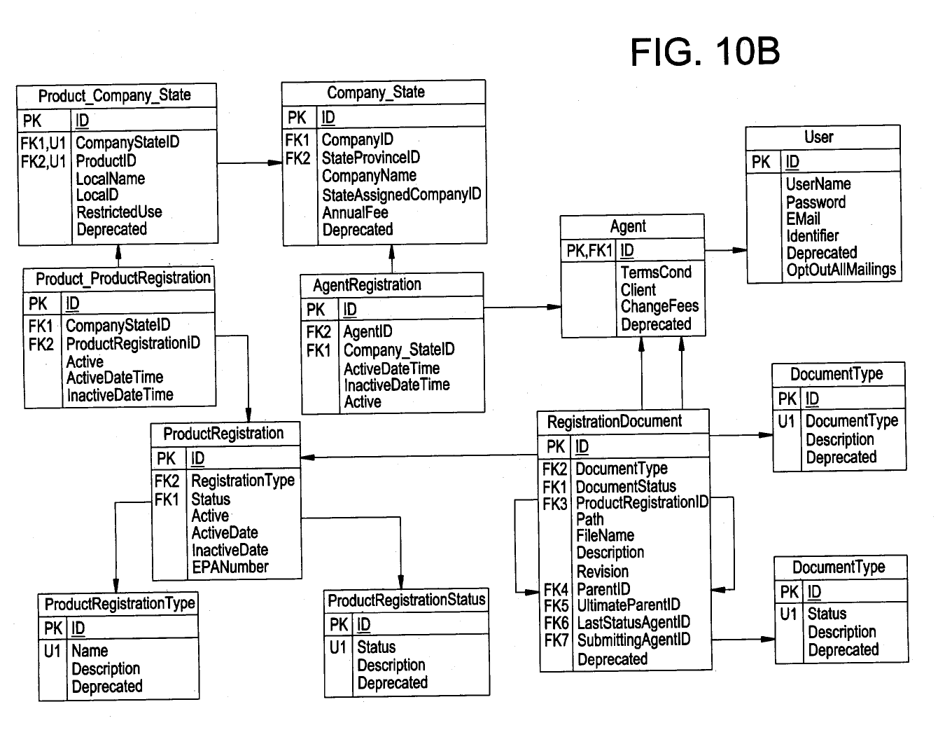

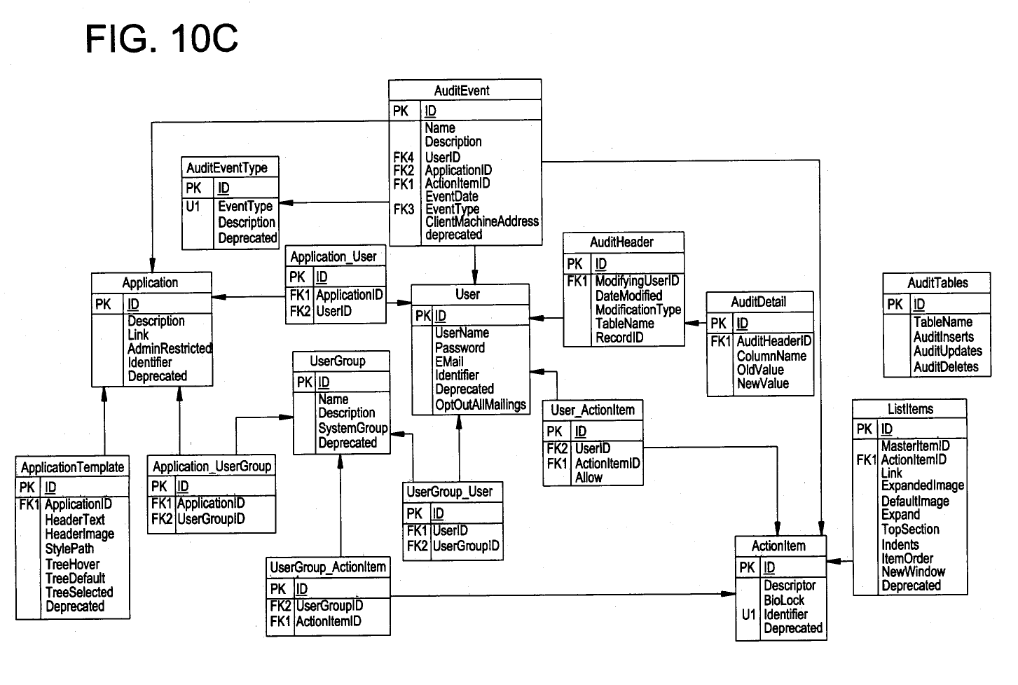

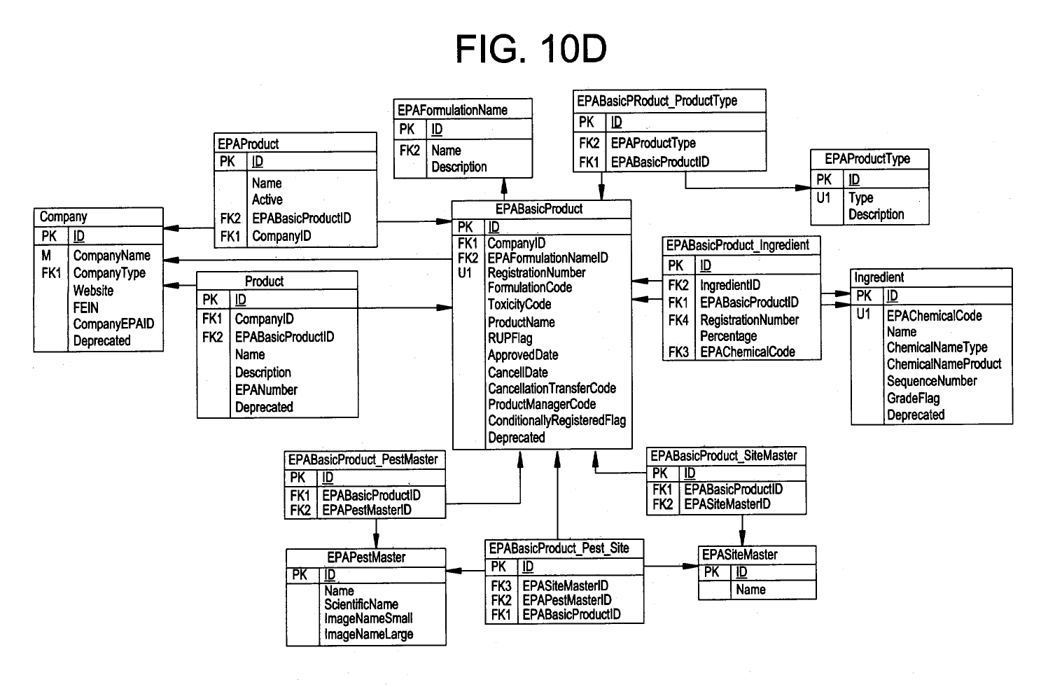

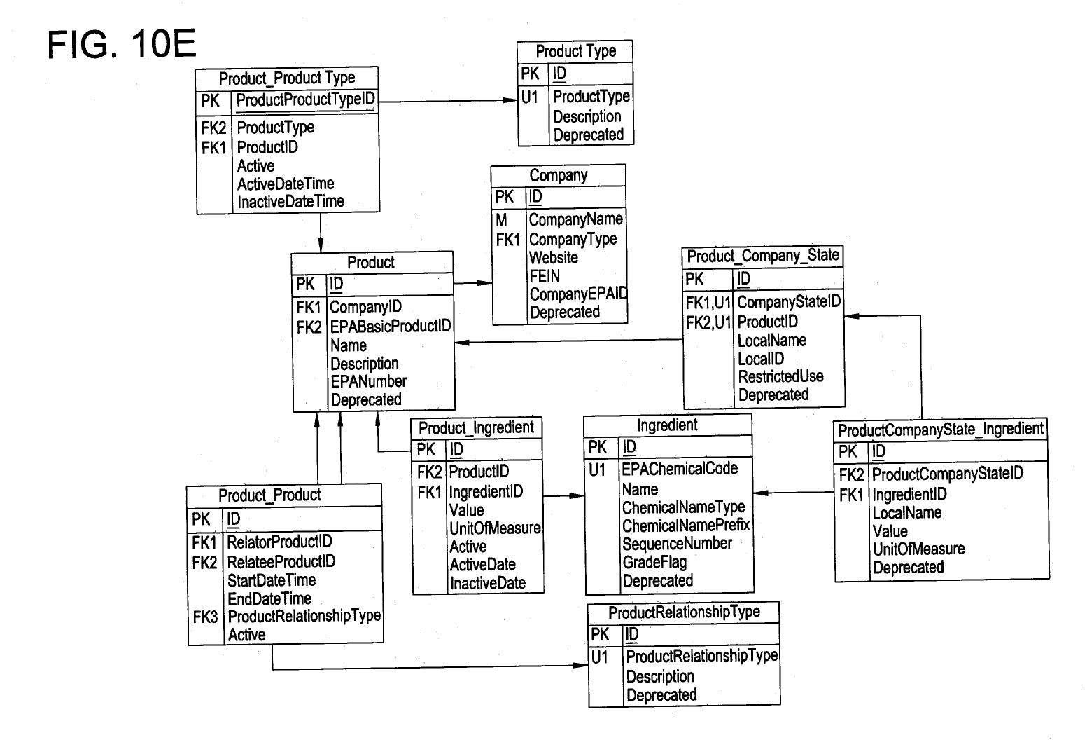

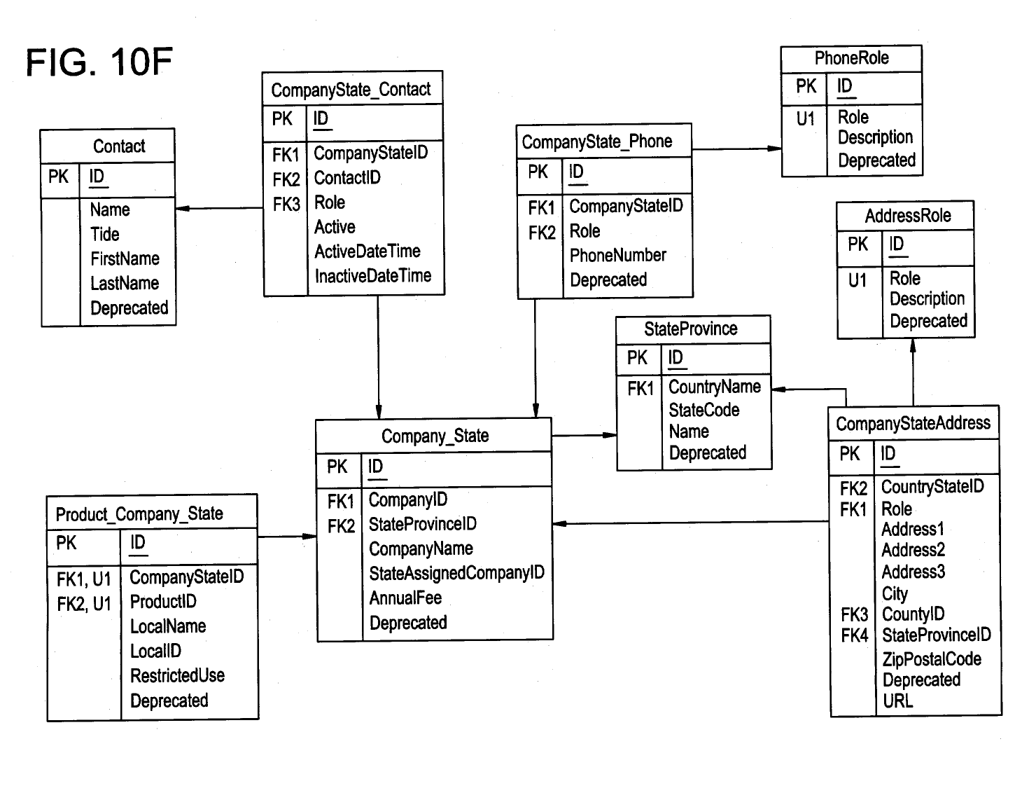

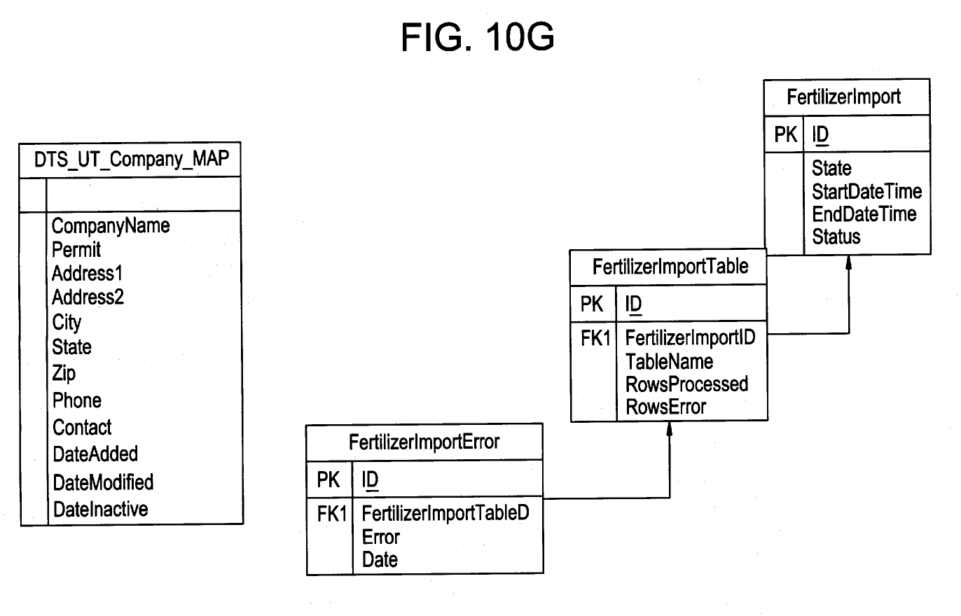

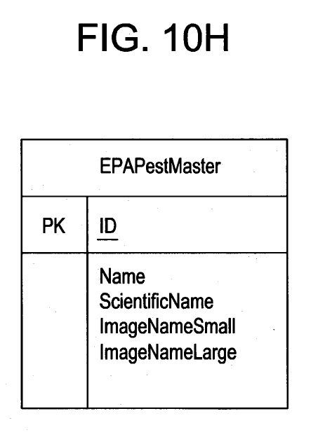

FIGS. 10A-H illustrate exemplary interrelationships of databases, all comprised within the security database, used in the system of the present invention. The databases shown in the Figures allow for the efficient matching of commodity chemicals, commodity products, and/or their active/inert ingredients across various commodity activity locations, while maintaining the uniqueness of the commodity chemical/product/ingredient within each commodity activity location, user authentication and authorization, auditing of every transaction that takes place over the security database, and connectivity to external databases used in reporting devices.

It should be noted that, for ease in illustration only, FIGS. 10A-H may illustrate the same database (e.g., the database labeled COMPANY) many times in order to clearly illustrate the relationships of those databases, and their contents, with others within the security database. Further, while not all of the databases are explicitly shown in the appended Figures, it is submitted that, based on the Figures provided, one of ordinary skill in the art may readily recognize and understand how various commodity activity elements may be arranged within the security database to achieve the principles of the present invention.

As mentioned above, the principles of the present invention allow for an activity matching process to be automatically or manually performed during or after the submission of commodity activity element sets by reporting agents. Accordingly, matching logic supported by the security database may perform a one-to-one or a many-to-one matching process on the commodity activity elements submitted from different commodity activity locations.

Generally, the matching logic uses commodity activity elements including, for example, UPC, EPA ID, trade name of commodity chemical or product, or other unique commodity chemical identifying information in each activity report to look up data records therein and thereby to determine corresponding and cross reference commodity chemical name(s), locations applied, distribution routes, services employing the commodity chemical, manufacturers of the inert/active ingredients in a commodity chemical, concentrations of commodity chemicals in water sources near application sites, etc.

For example, after an activity report specific to a first commodity activity location (e.g., state) containing a commodity chemical or product (e.g., Gardentech Ready-to-Use Insect Killer having an EPA ID 59144-2) is submitted to the security database a first time, a name may be assigned to the commodity chemical or product. Accordingly, any name assigned to the commodity chemical or product may be treated as a “master name” and any other commodity activity elements within the activity report (including commodity activity elements found within documents such as labels, MSDS, certificates, registrations, licenses, receipts, inventory lists, etc.) may then be associated with the master name. Accordingly, a master record may be created. When the commodity chemical or product is subsequently submitted to the security database in a subsequent activity report, specific to any of the first commodity activity location or a different commodity activity location, it is determined whether or not the commodity chemical or product in the subsequently submitted activity report is the same as the commodity chemical or product in the first submission. If the two commodity chemicals or products are the same, then all of the commodity activity elements within the subsequent activity report are associated with the commodity activity elements associated with the master record.

When, for example, one or more commodity activity elements within any of commodity chemical information or commodity product information (e.g., a UPC) of a commodity chemical or product are submitted to the activity database via an activity report specific to a first commodity activity location (e.g., a state), the particular commodity activity element(s) may be automatically or manually matched by the reporting agent to other commodity activity locations where that commodity chemical or product is known by the reporting agent to be used, produced, transported, stored, etc. Consequently, the matching logic looks up the master name for the submitted commodity chemical or product and associates that commodity activity element within the commodity chemical/product information with all other commodity chemicals/products in the other commodity activity locations.

In one aspect of the present invention, the reporting agent may be enabled to manually associate a commodity chemical or product specific to one commodity activity location with other chemicals/products in other locations by being presented with a list of other commodity chemicals or products that have the same commodity chemical/product information. Subsequently, the reporting agent selects from the list all of the commodity chemicals/products that match the chemical/product submitted.

In another aspect of the present invention, commodity activity elements within commodity chemical/product information (e.g., UPC, MSDS documents, labels, certificates, registrations, licenses, etc.) of a commodity chemical/product being submitted in one commodity activity location may be automatically associated with commodity chemicals/products in other commodity activity locations if the commodity activity elements submitted have already been matched to other commodity chemicals/products in other commodity activity locations.

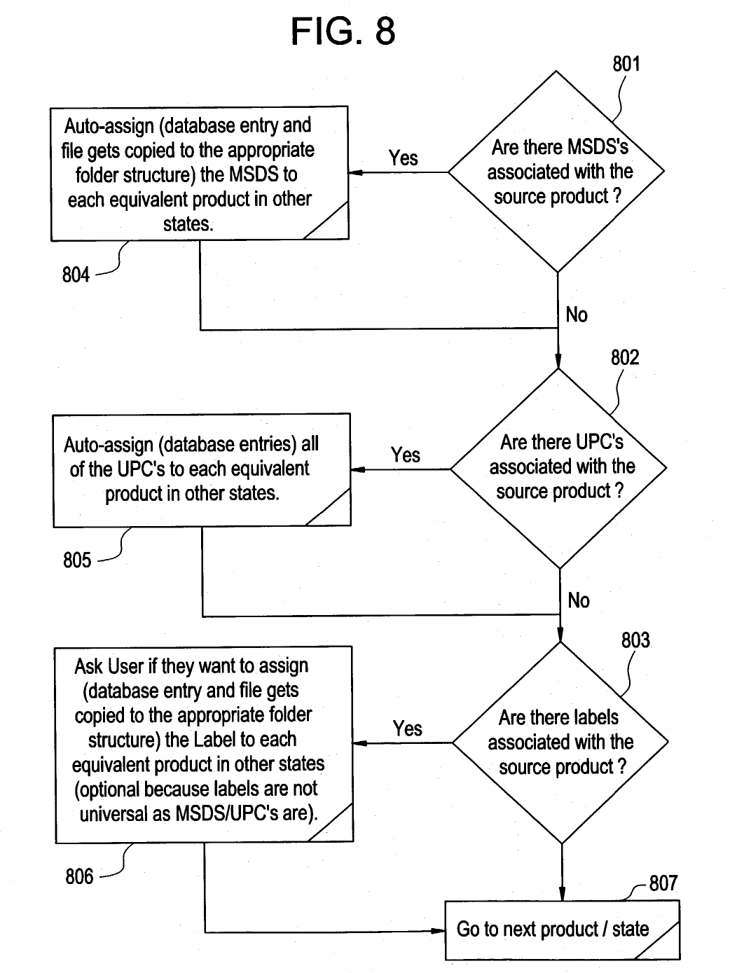

Referring to FIG. 8, in one exemplary aspect of the present invention, the matching logic first determines if there is are corresponding MSDS commodity activity elements and/or papers associated with the submitted commodity chemical, commodity product, and/or its inert/active ingredients (see step 801). If there are none, the matching logic determines if there are any corresponding UPC related commodity activity elements associated with the selected commodity chemical, commodity product, and/or its inert/active ingredients (see step 802). If there are none, the matching logic then determines if there are any corresponding label related commodity activity elements associated with the selected commodity chemical, commodity product, and/or its inert/active ingredients (see step 803). Accordingly, the matching logic prompts the user to select another commodity chemical, commodity product, and/or another state in which to start. If, however, corresponding MSDS, UPC, and label exists within the security database, matching logic automatically assigns any corresponding MSDS, UPC, and/or, optionally, other label information to each equivalent commodity chemical and/or its inert/active ingredients in other commodity activity locations (e.g., states) (see steps 804-806). Automatic assignment of label information is optional because labels are not as universal as MSDS or UPC information within different commodity activity locations. Accordingly, the matching logic creates data records and a file gets copied to appropriate folder structures within the security database to allow equivalent commodity chemicals/products in diverse commodity activity locations to share similar information (or at least be associated with one another). This matching process may be repeated for all commodity activity locations, and for all commodity chemicals, commodity products, and/or their inert/active ingredients in the selected state (see step 807).

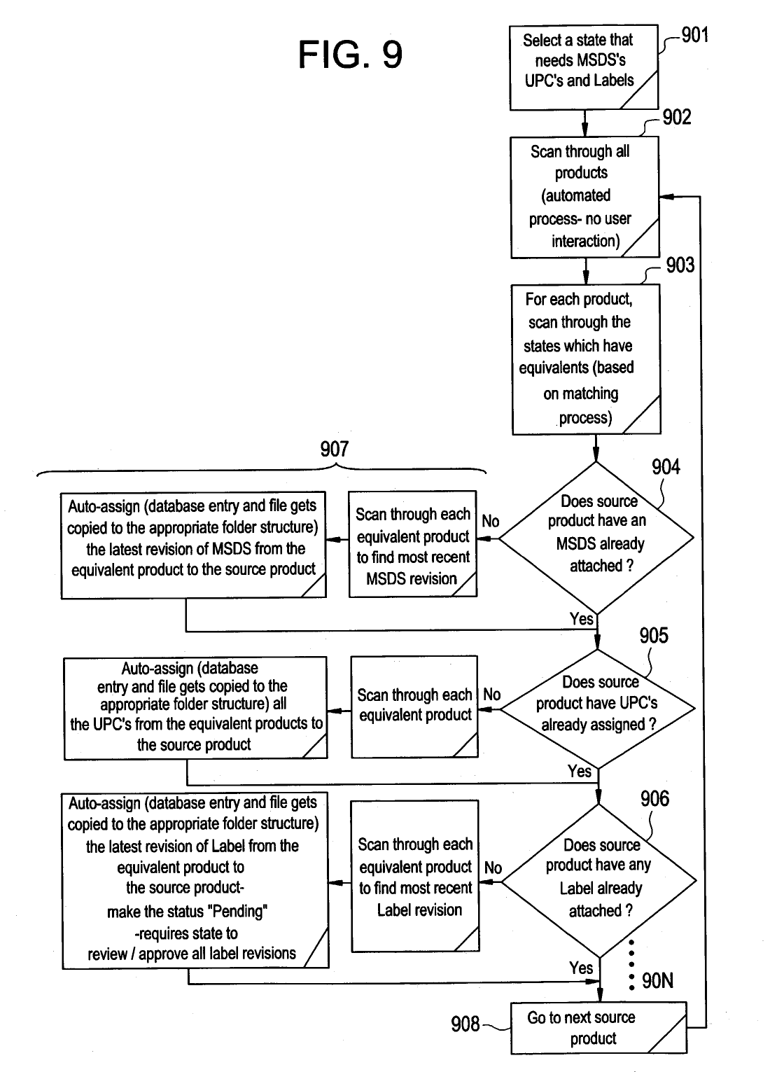

Referring to FIG. 9, simultaneously or after a commodity chemical or product in one commodity activity location has been matched to (or associated with) another commodity chemical/product in another commodity activity location, suitable portions of any of the aforementioned types of information originally submitted to the security database with respect to one commodity activity location may be associated with other commodity chemicals/products in other commodity activity locations. For example, a scan may be performed on all of the commodity activity elements identifying commodity chemicals and/or products in a particular commodity activity location (see step 901). For each commodity chemical or commodity product within the particular commodity activity location, a scan may be made (see step 902) and it may be determined which commodity chemicals or products in that commodity activity location have equivalents (see step 903). Accordingly, the matching logic determines if the scanned commodity chemical or product has MSDS (see step 904), UPC (see step 905), label information (see step 906), or data from any of the other aforementioned types of the information (see step 90N) already associated with it. If the submitted commodity chemical or product is not associated with any of the aforementioned types of, the matching logic scans through each equivalent chemical or product within the security database and finds the more recent data corresponding to the information missing. Subsequently, the matching logic auto assigns the most recent data from the equivalent commodity chemicals/products to the submitted commodity chemical/product (see step 907). Where appropriate, the matching logic auto-assigns the latest version of the label from the equivalent commodity chemicals to the scanned commodity chemicals or products, the matching logic marks the “status approval” database field with a “pending” status. Accordingly, a commodity activity element set for the scanned commodity chemical/product with the pending label version is communicated to appropriate governmental regulatory activity data source in the commodity activity location where that commodity chemical is registered such that the label version may be reviewed and/or approved. The auto assignment process may be repeated for all submitted commodity chemicals/products requiring updated information (see step 908).

In implementing the aforementioned matching processes, names of commodity activity elements (e.g., pesticides, fertilizer, feed, seed, chemical names, etc.) registered, applied, stored, sold, transported, or involved in some other event, in one commodity activity location may be matched with corresponding commodity activity elements in one or more commodity activity locations (e.g., states). Accordingly, upon selection of one or more commodity activity location and a commodity chemical or product by an user, a view-list of all of the other commodity activity locations in which the EPA ID, UPC, or data from another type of information defining the relation of a commodity chemical or product with an event (e.g., registration) is generated. The view list may also show the trade names of all the commodity chemicals sold in each of the selected states having the same EPA ID. Commodity activity elements generated by this matching process may be saved.

Geographical information systems capable of mapping representations of regions (countries, states, watersheds, counties, etc.) can often tell a greater story than purely raw data. Mapping software, tied to the security database, allows numerous commodity activity locations (e.g., businesses, well-heads, rivers, farms, factories, states, counties, highways, etc.) and quantities (e.g., amounts, concentrations, etc. of commodity chemicals, products, and/or their inert/active ingredients) to be graphically represented, using various GIS layers. For example, a map of South Dakota may be displayed illustrating rivers, reservoirs, lakes, streams, etc. Graphic representations of locations of fertilizer manufacturers, or amounts of Glyphosate (Roundup™) applied for working purposes may be overlayed over the map of South Dakota. Locations of feed-mills may also be mapped according to their spatial relationship to cattle concentrations within South Dakota. Further, GIS technology applied to the present invention may be used to track compliance characteristics or potential security threats or potential abnormally high concentrations of commodity chemicals from one regulatory region to another.

Using a query form supported by the security database, commodity activity elements may be queried and, when required, produce tabular or numerical reports. In one aspect of the invention, net calculations may be made to determine net use, production, transport, etc., of commodity chemicals, commodity products, and/or their inert/active ingredients.

As every aspect of this security system can be monitored, notification of suspicious events, such as multiple login attempts, security breaches, searches of specific key words, etc., to the proper authorities may provide a robust security system. Early warning messages may be generated and sent via email, pager or SMS (text messages to cell phones) to the appropriate authorities to oversee. Further, anomalies may also be monitored. For example, real time monitoring of purchases and applications may be made to determine concentration gradient spikes and/or hording of commodity chemicals and/or their inert/active ingredients, or combinations of product purchases that may cause triggers.

Moreover, determinations related to the use of binary chemicals may be facilitated with the principles of the present invention. Security authorities may be employed to analyze the data in various ways, and to provide guidance on what should be considered suspicious activities. For example, two products on their own may not be dangerous, but when used in combination could pose a threat. These combinations may be identified and monitored using data contained within the security database. The ability to track purchases and shipments of these products across state and international borders may help identify potentially harmful situations.

Predetermined, statistically derived, trigger levels at which to alert authorities may be put in place to monitor commodity chemicals, purchasers, applicators, distributors, and sellers to provide early warning signs of possible threats. These may be calculated over multiple intrastate or international transactions that are above normal standards.

Environmental and agricultural security requires more than simple documentation of compliance and registration. Environmental and agricultural security also requires effective identification, tracking, inspection, registration, licensing, authentication, mapping, and data distribution of environmental and agricultural products and activities and the effects of products and activities in the surrounding environment.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method organizing data elements within a database, comprising:
providing a first plurality of data elements to a database, wherein at least one first association exists between at least two of the data elements of the first plurality of data elements;
providing a second plurality of data elements to the database, wherein the second plurality of data elements are different from the first plurality of data elements; and
determining whether the at least one association exists between at least one of the second plurality of data elements and at least one of the at least two data elements of the first plurality of data elements.

2. The method of organizing data elements within a database according to claim 1, further comprising associating the at least one of the second plurality of data elements with the at least two data elements of the first plurality of data elements if it is determined that the first association exists between at least one of the second plurality of data elements and at least one of the at least two data elements of the first plurality of data elements.

3. The method of organizing data elements within a database according to claim 1, further comprising providing each of the first and second plurality of data elements to the database in a predetermined format, wherein the predetermined format is based on the source from where the plurality of data elements were provided.

4. The method of organizing data elements within a database according to claim 1, wherein the first plurality of data elements are specific to a first area and the second plurality of data elements relate to a second area, different from the first area.

5. A method of organizing information related to commodity chemicals, comprising:
providing a first commodity activity element set, wherein the first commodity activity element set comprises a first plurality of interrelated commodity activity elements;
providing a second commodity activity element set, wherein the second commodity activity element set comprises a second plurality of interrelated commodity activity elements and wherein the second commodity activity element set is different from the first commodity activity element set; and
determining whether at least two of the commodity activity elements from the first commodity activity element set are the same as at least two of the commodity activity elements from the second commodity activity element set.

6. A method of organizing information related to commodity chemicals according to claim 5, further comprising associating at least a portion of the first commodity activity element set with at least a portion of the second commodity activity element set if it is determined that at least two of the commodity activity elements from the first commodity activity element set are the same as at least two of the commodity activity elements from the second commodity activity element set.

7. The method of organizing information related to commodity chemicals according to claim 5, further comprising providing each of the first and second commodity activity element sets to the database in a predetermined format, wherein the predetermined format is based on the source from where the commodity activity element sets were provided.

8. The method of organizing information related to commodity chemicals according to claim 5, wherein the first commodity activity element set is specific to a first commodity activity location and the second commodity element set is specific to a second commodity activity location.

9. A system for organizing information related to commodity chemicals and commodity products, comprising:
a database for storing a plurality of commodity activity elements;
a plurality of activity data sources for submitting the plurality of commodity activity element sets, wherein each of the commodity activity element sets comprises the plurality of commodity activity elements; and
matching logic for determining whether an association exists between predetermined commodity activity elements in predetermined ones of the plurality of commodity activity element sets.
